(19) United States
(12) Patent Application Publication
(10) Pub. No.: US 2026/0082210 A1
(43) Pub. Date: Mar. 19, 2026

(54) Inventory Method and Communication Device

(71) Applicant: VIVO MOBILE COMMUNICATION CO., LTD., Dongguan (CN)

(72) Inventors: Junjie Tan, Dongguan (CN); Rongling Jian, Dongguan (CN); Wei Huang, Dongguan (CN)

(21) Appl. No.: 19/398,439

(22) Filed: Nov. 24, 2025

Related U.S. Application Data
(63) Continuation of application No. PCT/CN2024/094356, filed on May 21, 2024.

(30) Foreign Application Priority Data
May 24, 2023 (CN) 202310596867.7

(51) Int. Cl. H04W 8/22; H04W 74/0833

(52) U.S. Cl. CPC H04W 8/22; H04W 74/085

(57) ABSTRACT

An inventory method includes taking, by a first communication device, inventory of at least two second communication devices based on a multi-thread inventory process.

### CROSS-REFERENCE TO RELATED APPLICATIONS

This application is a Bypass Continuation Application of International Patent Application No. PCT/CN2024/094356 filed May 21, 2024, and claims priority to Chinese Patent Application No. 202310596867.7 filed May 24, 2023, the disclosures of which are hereby incorporated by reference in their entireties.

### BACKGROUND OF THE INVENTION

### Field of the Invention

This application pertains to the field of communication technologies, and in particular, relates to an inventory method and a communication device.

### Description of Related Art

In a radio frequency identification (RFID) backscatter communication (BSC) system, a reader/writer may implement identification and data transmission of a BSC device (such as an electronic tag) by using an inventory process.

### SUMMARY OF THE INVENTION

According to a first aspect, an inventory method is provided, and includes: taking, by a first communication device, inventory of at least two second communication devices based on a multi-thread inventory process.

According to a second aspect, an inventory method is provided, and includes: performing, by a second communication device, an inventory process with a first communication device based on a target transmission resource, where the inventory process corresponding to the second communication device and an inventory process corresponding to at least one third communication device belong to a same multi-thread inventory process performed by the first communication device.

According to a third aspect, an inventory apparatus is provided. The apparatus is applied to a first communication device and includes an inventory module. The inventory module is configured to take inventory of at least two second communication devices based on a multi-thread inventory process.

According to a fourth aspect, an inventory apparatus is provided. The apparatus is applied to a second communication device and includes an inventory module. The inventory module is configured to perform an inventory process with a first communication device, where the inventory process corresponding to the second communication device and an inventory process corresponding to at least one third communication device belong to a same multi-thread inventory process performed by the first communication device.

According to a fifth aspect, a communication device is provided. The communication device includes a processor and a memory. The memory stores a program or instructions executable on the processor, and when the program or the instructions are executed by the processor, the steps of the method according to the first aspect or the second aspect are implemented.

According to a sixth aspect, a communication device is provided and includes a processor and a communication interface. The communication interface is coupled to the processor, and the processor is configured to run a program or instructions to implement the steps of the method according to the first aspect, or to implement the steps of the method according to the second aspect.

According to a seventh aspect, a non-transitory readable storage medium is provided. The non-transitory readable storage medium stores a program or instructions, and when the program or the instructions are executed by a processor, the steps of the method according to the first aspect are implemented, or the steps of the method according to the second aspect are implemented.

According to an eighth aspect, a wireless communication system is provided and includes a first communication device and a second communication device. The first communication device may be configured to perform the steps of the method according to the first aspect, and the second communication device may be configured to perform the steps of the method according to the second aspect.

According to a ninth aspect, a chip is provided. The chip includes a processor and a communication interface, the communication interface is coupled to the processor, and the processor is configured to run a program or instructions to implement the steps of the method according to the first aspect or to implement the steps of the method according to the second aspect.

According to a tenth aspect, a computer program/program product is provided. The computer program/program product is stored in a non-transitory storage medium. The program/program product is executed by at least one processor to implement the steps of the method according to the first aspect or to implement the steps of the method according to the second aspect.

### BRIEF DESCRIPTION OF THE DRAWINGS

FIG. 1a is a schematic structural diagram of a wireless communication system according to an example embodiment of this application;

FIG. 1b is a constellation diagram of an OOK signal superimposed on an IQ plane according to an example embodiment of this application;

FIG. 1c is a schematic diagram of projection subspace according to an example embodiment of this application;

FIG. 1d is a schematic diagram when Tag B is asynchronous relative to Tag A according to an example embodiment of this application;

FIG. 1e is a schematic diagram of an HMM model according to an example embodiment of this application;

FIG. 2 is a schematic flowchart 1 of an inventory method according to an example embodiment of this application;

FIG. 3 is a schematic flowchart 2 of an inventory method according to an example embodiment of this application;

FIG. 4a is a schematic diagram of data truncation processing according to an example embodiment of this application;

FIG. 4b is a schematic flowchart 1 of an inventory interaction process according to an example embodiment of this application;

FIG. 4c is a schematic diagram of a state machine of a BSC according to an example embodiment of this application;

FIG. 4d is a schematic flowchart 2 of an inventory interaction process according to an example embodiment of this application;

FIG. 4e is a schematic flowchart 3 of an inventory interaction process according to an example embodiment of this application;

FIG. 4f is a schematic flowchart 4 of an inventory interaction process according to an example embodiment of this application;

FIG. 4g is a schematic flowchart 5 of an inventory interaction process according to an example embodiment of this application;

FIG. 5 is a schematic flowchart 3 of an inventory method according to an example embodiment of this application;

FIG. 6 is a schematic structural diagram 1 of an inventory apparatus according to an example embodiment of this application;

FIG. 7 is a schematic structural diagram 2 of an inventory apparatus according to an example embodiment of this application;

FIG. 8 is a schematic structural diagram of a communication device according to an example embodiment of this application;

FIG. 9 is a schematic structural diagram of a terminal according to an example embodiment of this application; and

FIG. 10 is a schematic structural diagram of a network-side device according to an example embodiment of this application.

### DESCRIPTION OF THE INVENTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6th generation (6G) communication system other than the NR system.

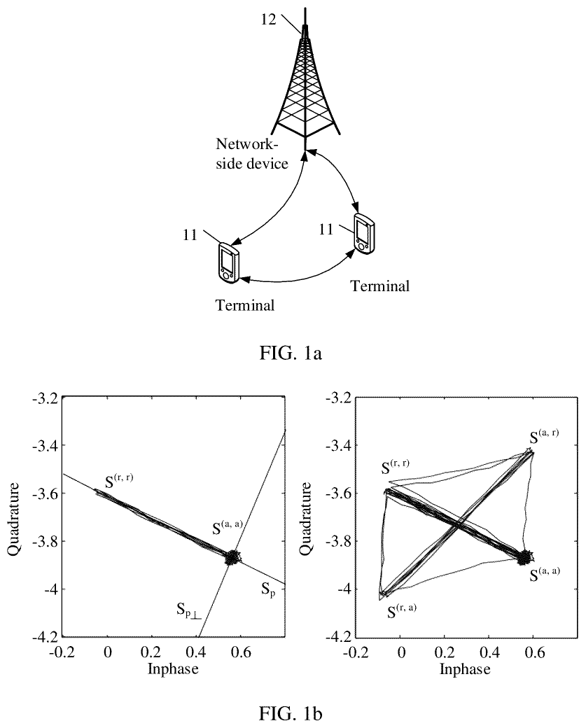

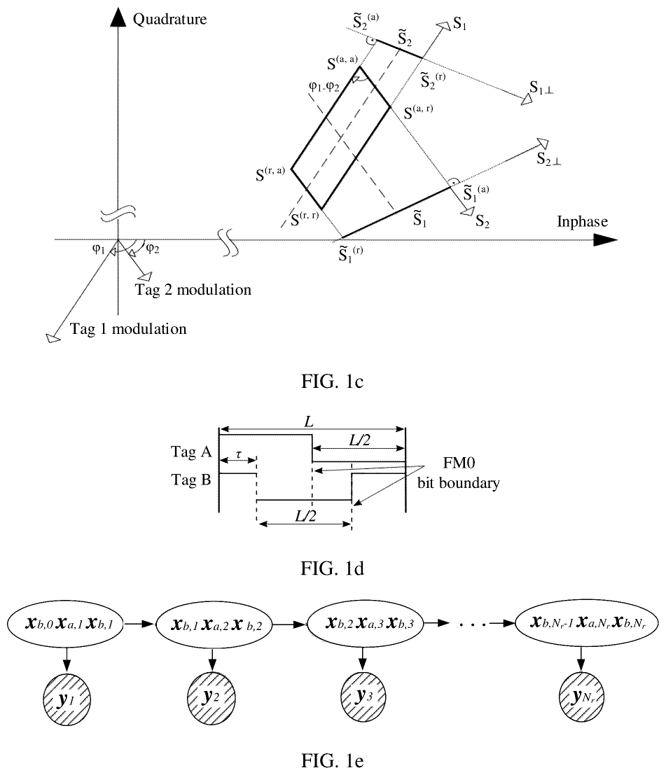

FIG. 1a is a block diagram of a wireless communication system to which an embodiment of this application is applicable. The wireless communication system includes a terminal 11 and a network-side device 12. The terminal 11 may be a mobile phone, a tablet personal computer a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the terminal 11 is not limited in this embodiment of this application. The network-side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (WiFi) node, or the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the field. The base station is not limited to a specific technical term, provided that a same technical effect is achieved. It should be noted that in the embodiments of this application, only a base station in an NR system is used as an example for description, and a type of the base station is not limited.

On the basis of the communication systems provided above, to help a person skilled in the art understand the technical solutions provided in the embodiments of this application, the following explains some terms or concepts used in the embodiments of this application. Details are as follows.

### 1. Conflict Signal Recovery Technology

A backscatter communication system is generally a communication system with a relatively low rate. That is, a rate of a tag reflected signal is generally far lower than a sampling rate of a reader/writer, and the reader/writer (or a receive end) also has more complex hardware and a relatively complex signal processing capability. Therefore, the receive end may detect and recover, by using a method such as zero forcing or over-sampling, conflict signals sent by a plurality of Tags. The conflict signal recovery technology may be roughly divided into three types, including a conflict signal recovery technology that relies only on an inphase quadrature (IQ) signal feature, a conflict signal recovery technology that uses encoding memorability, and a conflict signal recovery technology that combines an IQ signal feature with time domain dynamics. The following separately describes the three types of conflict signal recovery technologies.

### 1.1: Relying Only on an IQ Signal Feature (Zero Forcing Method)

Assuming that a modulation order of one Tag is M, a signal obtained by superimposing signals sent by N Tags generates a maximum of MN constellation points on an IQ plane. For example, a subfigure on the right side of FIG. 1b shows a constellation obtained by superimposing binary on-off keying (OOK) signals sent by two Tags on the IQ plane, which respectively corresponds to four states: (r,r), (r,a), (a,r), and (a,a), where a represents an absorbed signal (absorbed, corresponding to off of the OOK), and r represents a reflected signal (reflective, corresponding to on of the OOK).

The receive end maps a received signal to the IQ plane to obtain one of the four constellation points, but cannot distinguish a state of the two Tags corresponding to the constellation point. Therefore, the receive end further needs to mark the constellation diagram. This process may be completed based on a preamble sent by the Tag. The preamble is data appended to the first half of the signal sent by the Tag, and is used to assist the receive end in demodulate the data. Preambles sent by all Tags are the same, including the On and Off states. In this case, when both of the two Tags synchronously send signals, the receive end may learn constellation points corresponding to the two states (r,r) and (a,a). Then, if two Tags have two different bits in the data part, two other constellation points may be obtained, and it is learned that the two constellation points certainly correspond to the two states (a,r) and (r,a). Due to impact of noise, a point cloud is formed at an actual constellation point obtained by the receive end. To obtain a more accurate constellation diagram, an average value usually needs to be obtained through a plurality of times of sampling, so as to obtain four relatively accurate constellation points.

Although the receive end cannot know, except (r,r) and (a,a), whether the other two constellation points correspond to (a,r) or (r,a), for decoding at the physical layer, no sequence needs to be specified, and it is only necessary to permanently assume one point to be (a,r), and the other point to be (r,a). Then, (r,r) and (r,a) may be connected to obtain projection subspace in which a signal of the first Tag is forced to zero, so as to determine the signal of the first Tag; (r,r) and (a,r) may be connected to obtain projection subspace in which a signal of the second Tag is forced to zero, so as to determine the signal of the second Tag, as shown in FIG. 1c.

The foregoing process may alternatively be combined with successive interference cancellation (SIC). First, a signal of one Tag is decoded; next, an interfering signal is reconstructed after decoding and checking through cyclic redundancy check (CRC); then, a signal of a second Tag is decoded.

It should be noted that, the foregoing process is described by using an example in which the receive end is a single antenna. In a case of a plurality of antennas, projection subspace of each antenna needs to be separately obtained, and then is combined into a matrix form, which is not described herein.

In summary, the zero forcing method is applicable when a quantity of conflict Tags is relatively small (for example, two Tags). To accurately obtain the projection subspace, the Tag needs to be completely synchronized at a symbol level. That is, a time error of signals of a plurality of Tags at the receive end should be far less than a width of one signal burst.

### 1.2: Encoding Memorability

FM0 code is a line encoding method facilitating Tag implementation, and is a type of encoding having memorability. It is assumed that signals of two Tags are asynchronous at the receive end. For example, FIG. 1d is a schematic diagram when Tag B is asynchronous τ relative to Tag A.

In this case, a relational expression among a sent signal (an ith symbol of the Tag a is denoted as x_{a,i} and similarly, x_{b,i} may be obtained), a received signal (an ith received symbol is denoted as yᵢ), and an asynchronous time difference may be constructed by using the memorability of the FM0 code.

$${y}_{i} = {h}_{a} \sqrt{\frac{{E}_{bit}^{a}}{E [ {\vert {h}_{a} \vert}^{2} ]}} {x}_{a , i} + {B}_{( i - 1 , i )} {h}_{b} \sqrt{\frac{{E}_{bit}^{b}}{E [ {\vert {h}_{b} \vert}^{2} ]}} {x}_{b , i} + {n}_{i}$$

In the expression, x_{a,i},x_{b,i}∈{e₀,e₁}, and e₀,e₁ is a basic sending waveform of the FM0; hₐ and h_{b} are respectively channels from Tag A and Tag B to the receive end;

$${E}_{bit}^{a} and {E}_{bit}^{b}$$

are average energy for sending one bit by Tag A and Tag B, respectively; nᵢ is noise of the ith symbol; B_{(i-1,i)} is a deterministic transition matrix, which is determined by a sent signal of a current symbol x_{b,i} and a sent signal of a previous symbol x_{b,i-1} of Tag B, and τ, and may be denoted as B_{(i-1,i)}=B(τ,x_{b,i-1},x_{b,i}). In FIG. 1d, “boundary” is a boundary.

Therefore, it can be learned that yᵢ is determined by x_{b,i-1}, x_{a,i}, and x_{b,i}·{x_{a,1}, . . . , x_{a,N}} and {x_{b,0}, . . . , x_{b,N}} may be obtained based on an observation sequence {y₁, . . . , y_{N}}, which form a Hidden Markov Model (HMM) model. As shown in FIG. 1e, the model may be solved by a Viterbi algorithm.

In summary, the conflict signal cancellation method implemented by using the encoding memorability method is applicable only to a case of two Tags. In this case, the Tags need to be kept asynchronous at the symbol level, and a time drift of each Tag at the adjacent symbol should be far less than the width of one signal burst.

1.3: Combining an IQ Signal Feature with Time Domain Dynamics

The foregoing two types of methods in 1.1 and 1.2 rely only on IQ signals to separate signals of a plurality of Tags, but cannot be used when a quantity of Tags is relatively large. A main reason is that a quantity of potential constellation points on the IQ plane will exponentially increase with the quantity of Tags, making it difficult to perform analysis and quick solution. More importantly, more constellation points greatly reduce discriminability of constellation points.

It is noted that a communication rate of the Tag is usually lower than a sampling rate of the reader/writer. For example, the sampling rate of the reader/writer is 25 Msps, whereas the communication rate of the Tag is 100 Kbps. Because time domain resolution of the receive end is higher, as long as a signal sent by the Tag is slightly staggered in time, the receive end can discriminate a change of the signal, that is, a so-called “edge”. Ideally, if all Tags are asynchronous, one Edge corresponds to a signal sent by one Tag. There are three possibilities: “rising”, “falling” and “unchanged” at the origin. Generally, one Edge occupies approximately three sample points. Therefore, a maximum of 83 Edges can be accommodated within a time length of 1-bit information sent by the Tag. It should be noted that the foregoing value depends on an actual hardware design.

The receive end may detect the Edge by comparing received signals at moments before and after a specific time point, to obtain information about a single Tag carried in the Edge, ΔS (t)=S (t₊)−S(t₋).

$$S ( t ) = {\sum }_{j = 1}^{N} {S}_{I}^{j} ( t ) + {iS}_{Q}^{j} ( t ) ; {S}_{I}^{j} ( t ) and {S}_{Q}^{j} ( t )$$

are respectively signals sent by a j-th Tag on I and Q channels at a moment t. However, after the Edge is detected, the receive end still cannot know bit information corresponding to the signal. Therefore, the Tag further needs to insert an anchor bit into a data packet to discriminate and mark the bit.

In an actual operation, ideal asynchronization is relatively difficult. If more than one Tag (for example, k Tags) conflict on a same Edge, 3k possible constellation points are generated. In this case, technologies such as those in 1.1 and 1.2 need to be used. In this case, performance is degraded to some extent. To alleviate this problem, asynchronization may be actively introduced. For example, time is divided into a plurality of frames, and all Tags reselect a time offset in each frame header. In addition, if more than one Tag selects a same time offset, in this case, an Edge conflict cannot be avoided. In this case, the receive end needs to reconstruct 3k constellation points, and sufficient conflict signal samples are required for clustering. To this end, the communication rates of all Tags may be set to a multiple of a base rate. Consequently, the Tags periodically continue to conflict on some Edges. It should be noted that the probability of the Edge conflict may alternatively be reduced by actively reducing the communication rate of the Tag.

In summary, the conflict signal recovery method that combines an IQ signal feature with time domain dynamics is applicable to a case of many Tags. An essence of this method is that high resolution in time domain is used to separate signals of a plurality of Tags, and in a case of an Edge conflict, this method is degraded to the methods provided in 1.1 and 1.2. Reliability may be improved by manually adding methods such as a time offset, rate multiplication, and adaptive adjustment of a communication rate.

### 2. RFID Tag Inventory Process

RFID is a conventional backscatter communication system. A main design objective of RFID is to perform identifier (ID) identification and data reading on a BSC device (that is, a Tag) in a coverage area range of a reader/writer. Because RFID is originally applied to automated inventory of a large quantity of goods, a process of identifying the Tag and reading data from the Tag is also referred to as inventory.

The EPC C1G2 RFID system defined in ISO 18000-6c is used as an example. After the reader/writer sends a query instruction (Query), the Tag responds with a reply. In an example in which the Reply is a 16-bit random number (RN16), the Tag generates a 16-bit random number (RN16) and sends the random number to the reader/writer, and then the reader/writer sends the sequence RN16 to the Tag by using an acknowledgement (ACK) instruction. After successfully verifying the RN16 in the ACK, the Tag sends subsequent data (for example, factory numbers such as a personal computer (PC) number, extended protocol control (XPC), and an electronic product code (EPC)) to the reader/writer.

Clearly, there may be a plurality of or even a large quantity of Tags within a coverage area of the reader/writer. If an inventory process of a single Tag is directly applied to a scenario of a plurality of Tags, there may be a case that a plurality of Tags simultaneously send backscatter signals, and consequently the signals conflict and cannot be decoded. Therefore, to adapt to the scenario of a plurality of Tags, the RFID system usually has a contention-based access mechanism for managing conflicts. Similarly, an EPC C1G2 RFID system is used as an example. The following shows an inventory process that combines the contention-based access mechanism.

Step 1: A reader/writer sends a select command to select a Tag of which inventory needs to be taken.

Step 2: The reader/writer sends a Query command to enable one round of inventory, where the Query indicates a value Q of a control counter.

Step 3: All Tags generate a random integer in a range of [0, 2^{Q}−1] as an initial value of the counter.

Step 4: The Tag checks whether the counter is 0.

Step 5a: If there is a Tag whose counter is 0, the Tag whose counter is 0 sends a Reply that includes a randomly generated 16-bit random number, which is denoted as RN16.

Step 6a: If the reader/writer successfully decodes the RN16, the reader/writer sends an ACK command that includes the RN16 and a 2-bit command field.

Step 7: The Tag receives the ACK, and checks whether the RN16 included in the ACK is the previously sent RN16.

Step 8a: If the RN16 is correct, the Tag for which RN16 verification is correct sends, to the reader/writer, data that needs to be reported, such as a PC, XPC, an EPC, or other data. Inventory of the Tag is completed.

Step 8b: If the RN16 is incorrect, the Tag for which RN16 verification is incorrect sets the counter of the Tag to a maximum value.

Step 6b: If the reader/writer fails to decode the RN16, the reader/writer sends a non-acknowledgement (NACK) command.

Step 9: If a Tag that receives the NACK command sends a Reply in a previous adjacent time sequence, the Tag sets the counter of the Tag to a maximum value.

Step 5b: If there is no Tag whose counter is 0, the reader/writer sends a query repetition (QueryRep) command.

Step 10: A Tag that receives the QueryRep command subtracts the counter of the Tag by 1.

Step 11: The reader/writer may send a query adjustment (Query Adjust) command to reconfigure a Q value.

Step 12: A Tag that receives the Query Adjust command and that does not complete an inventory process randomly reselects an integer in the range of [0, 2^{Q}−1] as the counter.

Step 13: Repeat steps 4 to 12 until inventory of all Tags is completed.

It can be learned that in the foregoing inventory process, the reader/writer can only receive, at a same moment, a signal sent by one Tag. When a plurality of Tags send data, signals of the Tags may conflict, and consequently, the reader/writer cannot correctly decode data of more than one Tag, which means “single-thread” inventory, thereby leading to low inventory efficiency. As a result, the foregoing inventory process does not adapt to an inventory scenario of a plurality of Tags.

Usually, only a BSC device that initiates access and that is uniquely acknowledged successfully can obtain a transmission opportunity, thereby implementing inventory of the BSC device. However, a problem such as low inventory efficiency exists in the inventory process.

This application provides an inventory method, so as to implement multi-thread inventory and improve inventory efficiency. A technical solution provided in embodiments of this application is described in detail below with reference to the accompanying drawing by using some embodiments and application scenarios thereof.

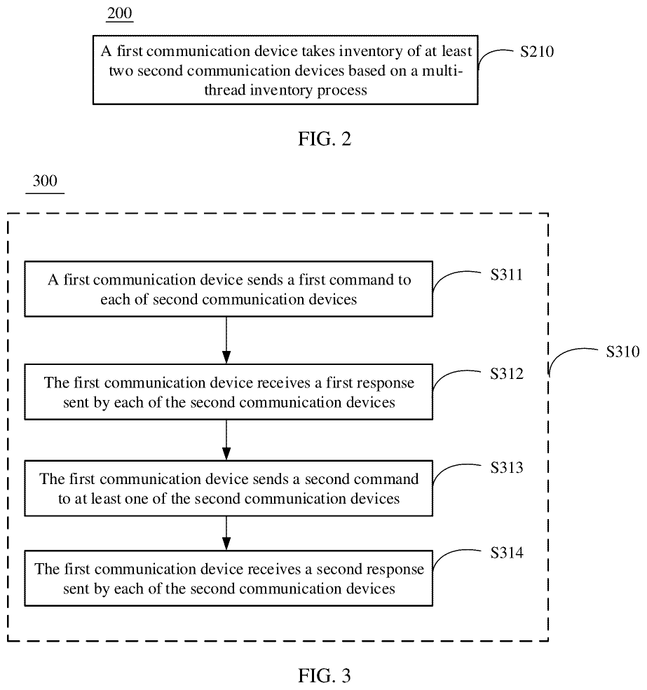

FIG. 2 is a schematic flowchart of an inventory method 200 according to an example embodiment of this application. The method 200 may be performed by but is not limited to a first communication device, and may be performed by hardware or software installed in the first communication device. In this embodiment, the method 200 may include at least the following steps.

S210: A first communication device takes inventory of at least two second communication devices based on a multi-thread inventory process.

In comparison with a problem such as low inventory efficiency exists in a single-thread inventory manner in which a reader/writer can only successfully detect, at a same moment, a signal sent by one BSC device, the first communication device provided in this application can take inventory of at least two second communication devices based on a multi-thread inventory process. Therefore, communication data (such as signaling, a command, or application data) sent by two or more second communication devices can be successfully detected at a same moment. In other words, in this application, the first communication device provided can successfully detect, at a same moment, information sent by two or more second communication devices, so as to implement a multi-thread inventory process for two or more second communication devices, thereby improving inventory efficiency. The multi-thread inventory process is applicable to a multi-device inventory scenario.

In a possible implementation, it is considered that in an inventory process, a first response (or referred to as a contention channel data packet) that is sent by the second communication device (that is, a device of which inventory is to be taken, such as the foregoing Tag) and that is used to respond to a query command or the like is critical to inventory efficiency, and the contention channel data packet generally features a basically fixed length and a relatively low requirement for a transmission rate. Therefore, in this application, a same transmission resource is shared by a plurality of second communication devices to send contention channel data packets, and the first communication device enables a plurality of parallel inventory threads, that is, a multi-thread inventory process for these second communication devices, so that in addition to improving inventory efficiency and avoiding a failure to send a contention data packet, the first communication device can choose to give way to the second communication device with a plurality of threads to send other signaling interaction data and application data in an orthogonal transmission manner or a non-orthogonal transmission manner, thereby ensuring smooth execution of the multi-thread inventory process. On this basis, in this application, the multi-thread inventory process is distinguished based on whether each of the second communication devices synchronously performs an inventory process or asynchronously performs an inventory process on a plurality of threads, and whether communication data (such as signaling or a command) other than the contention channel data packet is transmitted by using an orthogonal transmission resource or a non-orthogonal transmission resource. For example, the multi-thread inventory process may include but is not limited to at least one of (a) to (d) below.

(a) The at least two second communication devices synchronously perform the inventory process, and perform communication data transmission in the inventory process based on an orthogonal transmission resource.

The synchronously performing the inventory process may be understood as that different second communication devices process or wait to process same communication data (for example, signaling or a command) from the first communication device at any moment in the inventory process. For example, when all the second communication devices are sending contention channel data packets or sending application data, it may be determined that all the second communication devices synchronously perform the inventory process.

The orthogonal transmission resource is a transmission resource that is used by different second communication devices in a non-overlapping or non-sharing manner. In other words, the second communication devices communicate with the first communication device based on different transmission resources.

(b) The at least two second communication devices synchronously perform the inventory process, and perform communication data transmission in the inventory process based on a non-orthogonal transmission resource.

The synchronously performing the inventory process means that different second communication devices process or wait to process same communication data (for example, signaling or a command) from the first communication device at any moment in the inventory process. For example, when all the second communication devices are sending contention channel data packets or sending application data, it may be determined that all the second communication devices synchronously perform the inventory process.

The non-orthogonal transmission resource is a transmission resource that is used by different second communication devices in an overlapping or sharing manner. In other words, the second communication devices communicate with the first communication device based on a same transmission resource or partially same transmission resources.

(c) The at least two second communication devices asynchronously perform the inventory process, and perform communication data transmission in the inventory process based on an orthogonal transmission resource.

The asynchronously performing the inventory process means that different second communication devices are allowed to process or wait to process different communication data (for example, signaling or a command) from the first communication device at a same moment. For example, if some second communication devices are in a state of sending contention channel data packets, and some second communication devices are in a state of sending application data, it may be determined that all second communication devices asynchronously perform the inventory process.

The orthogonal transmission resource is a transmission resource that is used by different second communication devices in a non-overlapping or non-sharing manner. In other words, the second communication devices communicate with the first communication device based on different transmission resources.

(d) The at least two second communication devices asynchronously perform the inventory process, and perform communication data transmission in the inventory process based on a non-orthogonal transmission resource.

The asynchronously performing the inventory process means that different second communication devices are allowed to process or wait to process different communication data from the first communication device at a same moment. For example, if some second communication devices are in a state of sending contention channel data packets, and some second communication devices are in a state of sending application data, it may be determined that all second communication devices asynchronously perform the inventory process.

The non-orthogonal transmission resource is a transmission resource that is used by different second communication devices in an overlapping or sharing manner. In other words, the second communication devices communicate with the first communication device based on a same transmission resource or partially same transmission resources.

Based on the foregoing description, in a possible implementation, the first communication device mentioned in the context of this application may be but is not limited to a network-side device (for example, a base station), a terminal, a dedicated reader/writer, or the like. The second communication device may also be understood as a BSC device, which may be but is not limited to an RFID Tag, a passive internet of things (IoT) device, an active IoT device, a half-passive IoT device, or the like. A network architecture involved in a multi-thread inventory process implemented based on the first communication device and at least two second communication devices may be a network deployment architecture such as a monostatic system or a bistatic system, or the like, which is not limited herein.

In addition, in this application, the data sent by the foregoing second communication device in the inventory process may be classified into two types.

Type 1: A control signaling type, such as a contention channel data packet, is a first data packet sent by the second communication device in a random access process, such as a temporary identifier (such as RN16). This is a random number with a fixed length of 16 bits. Such a data packet usually has a fixed length, and has a low requirement for a transmission rate.

For another example, other signaling interaction data and other signaling data except the contention channel data packet usually have a fixed length, and usually have a low requirement for a transmission rate.

Type 2: A service data type, such as sensor information. This type of data may have an unfixed length and may have an unfixed requirement for a transmission rate.

In this embodiment, the first communication device takes inventory of at least two second communication devices by using the multi-thread inventory process, thereby effectively improving inventory efficiency. The multi-thread inventory process is applicable to a multi-device inventory scenario.

FIG. 3 is a schematic flowchart of an inventory method 300 according to an example embodiment of this application. The method 300 may be performed by but is not limited to a first communication device, and may be performed by hardware or software installed in the first communication device. In this embodiment, the method 300 may include at least the following steps.

S310: A first communication device takes inventory of at least two second communication devices based on a multi-thread inventory process.

It may be understood that, for an implementation process of S310, reference may be made to related descriptions in the method embodiment 200. In addition, in a possible implementation, as shown in FIG. 3, in a process in which the first communication device takes inventory of the at least two second communication devices based on the multi-thread inventory process, the multi-thread inventory process may include but is not limited to S311 to S314 shown in FIG. 3, and content is as follows.

S311: The first communication device sends a first command to each of the second communication devices.

The first communication device may send the first command to two or more second communication devices in an orthogonal transmission manner, so as to indicate or trigger the second communication device to contend for a channel, and related information about channel contention performed by each of the second communication devices, such as a parameter related to conflict signal recovery. The orthogonal transmission manner may be but is not limited to time division multiplexing (TDM), frequency division multiplex (FDM), code division multiplexing (CDM), or the like, so as to ensure reliability of data transmission. Certainly, similar to the first command, both a subsequent second command and a subsequent third command may also be sent in the orthogonal transmission manner.

Optionally, in this embodiment, the first command may be a query command, a query repetition (QueryRep) command, a query adjustment (QueryAdjust) command, a paging message, a wake-up signal, or the like. On this basis, the first command may include or indicate at least one of (11) to (16) below, so that the first communication device can have a capability of processing communication data sent by at least two second communication devices on a same transmission resource, thereby helping implement the multi-thread inventory process.

(11) First synchronization information, used to align a time of each of the second communication devices, so that the first communication device can perform multi-thread decoding or the like on simultaneously received communication data (for example, a first response in S312) sent by two or more second communication devices.

Optionally, the first synchronization information may be a preamble, a timing advance (TA) offset, or the like, and may be used for synchronization of each second communication device at a data packet level, for example, a time used by each second communication device to align and process or wait to process communication data (for example, a command or signaling) based on the first synchronization information, or a time at which communication data (for example, a command or signaling) is sent to the first communication device, which is not limited herein.

It may be understood that the first synchronization information may be the same as or different from the second synchronization information and the third synchronization information that are subsequently mentioned. For example, the first synchronization information, the second synchronization information, and the third synchronization information may be all used by a same second communication device to perform time alignment, or may be used by different second communication devices to perform time alignment.

(12) A first rate or a first rate offset (or referred to as a bias), used to indicate a rate or a rate offset with which the second communication device sends first communication data.

The first rate may be a symbol rate or a bit rate. Correspondingly, the first rate offset may also be a symbol rate offset or a bit rate offset. In this embodiment, a value of the first rate or the first rate offset may be determined according to a conflict signal recovery technology used when the first communication device processes a plurality of pieces of conflict communication data.

It may be understood that for different second communication devices, the first rates or the first rate offsets may be the same or different. Optionally, in different cases, the first command may further include or indicate a first rate offset.

It should be noted that a demodulation success rate (or a quantity of concurrent data streams that can be successfully decoded) of the conflict signal recovery technology is negatively correlated with a data rate. Therefore, considering that a first response (or referred to as a contention channel data packet) that is sent by the second communication device and that is used to respond to the first command requires higher reliability, if the first response is not successfully decoded, remaining transmission data cannot be scheduled. Therefore, a rate of the contention channel data packet may be appropriately reduced, and the number of the second communication devices for concurrent communication can be increased.

In addition, data other than the first response is easily transmitted in batches through scheduling. Therefore, during subsequent scheduling, a transmission rate may be appropriately increased.

In other words, in this application, the first rate (or the first rate offset) may be the same as or different from the second rate (or the second rate offset) and the third rate (or the third rate offset) that are subsequently mentioned, which is not limited herein.

(13) A first start time or a first start time offset, used to indicate a start time or a start time offset with which the second communication device sends communication data (for example, the first response), so that the first communication device performs conflict recovery.

A value of the first start time or the first start time offset may be determined according to a conflict signal recovery technology used when the first communication device processes a plurality of pieces of conflict communication data.

It may be understood that, in this embodiment, each of the second communication devices may be bit-level synchronization (that is, synchronous execution of an inventory process) or bit-level asynchronization (that is, asynchronous execution of an inventory process). In a case of synchronization, the first communication device may indicate a start time to each of the second communication devices by using first signaling.

In a case of asynchronization, the first communication device may respectively indicate different start time offsets to the second communication devices by using first signaling. For example, if the conflict signal recovery technology used by the first communication device requires that the information sent by the second communication device be asynchronous to some extent at the bit/symbol level, a start time or a relative start time offset value for sending data by each of the second communication devices may be indicated based on the foregoing “synchronization information”.

It should be noted that the first start time (or the first start time offset) may be the same as or different from the second start time (the second start time offset) and the third start time (or the third start time offset) that are subsequently mentioned, which is not limited herein.

(14) Configuration information of a first reference bit.

The first reference bit is used by the first communication device to decode the received communication data sent by the second communication device, for example, is used to discriminate and mark a bit. Reference may be made to the related description of the anchor bit in 1.3 above. In this embodiment, the configuration information includes a position or a length of the reference bit.

It should be noted that the first reference bit may be the same as or different from the second reference bit and the third reference bit that are subsequently mentioned, which is not limited herein.

(15) Modulation-related information of a first signal, where the modulation-related information of the first signal includes a modulation scheme or a modulation order. In other words, the modulation-related information of the first signal is used to indicate a modulation scheme or a modulation order used when the second communication device sends communication data.

It should be noted that the modulation-related information of the first signal may be the same as or different from the modulation-related information of the second signal and the modulation-related information of the third signal that are subsequently mentioned, which is not limited herein.

(16) A length of a first identifier. The length of the first identifier is used to indicate a length of a first identifier used when the second communication device determines to respond to the first command.

In this embodiment, the first identifier includes a device identifier or a temporary identifier of the second communication device, so as to represent an identity of the second communication device, so that the first communication device can uniquely determine the second communication device based on a first identifier carried in received communication data such as a first response.

In this embodiment, the first identifier may include the device identifier or the temporary identifier (such as a 16-bit random number (RN16)) of the second communication device, and the device identifier may be but is not limited to a factory serial number, a device ID, a user ID, an IP address, a medium access control (MAC) address, a radio network temporary identifier (RNTI), or the like.

It should be noted that, in addition to the information in (11) to (16) above, the foregoing first command may further include more or less information than the information described above, which is not limited herein.

In addition, according to different inventory scenarios such as synchronization or asynchronization, the first command may be sent in a manner of a broadcast command or a unicast command. Certainly, if the first command is sent by using a unicast command, the unicast command may further carry a device identifier or a temporary identifier of a corresponding second communication device, in order for each second communication device to accurately receive and identify the first command.

In another possible implementation, the first command may alternatively be transmitted by using any one of dedicated signaling (such as an ACK or a NACK), a system message, radio resource control (RRC) signaling, a medium access control control element (MAC CE), downlink control information (DCI), uplink control information (UCI), sidelink control information (SCI), and a physical frame preamble.

Certainly, in this application, the first command, the subsequent second command, the subsequent third command, and the like may be scrambled by using a part or all of the first identifier to ensure integrity of the transmission, and may further indicate that the command is configured for a specific second communication device. For example, only the specific second communication device can successfully decode the received command.

S312: The first communication device receives a first response sent by each of the second communication devices.

The first response is sent by each second communication device to the first communication device according to the received first command, so as to respond to the first command, and perform channel contention with another second communication device.

Optionally, in this embodiment, the first response includes or indicates at least one of (21) to (26) below.

(21) The first identifier, where the first identifier includes the device identifier or the temporary identifier of the second communication device.

The first identifier is used to represent the identity of the second communication device, so as to uniquely determine the second communication device. In this embodiment, the first identifier may be determined by the second communication device after receiving the first command, and may include the device identifier (such as a factory serial number, a device ID, a user ID, an IP address, a MAC address, or an RNTI) or the temporary identifier (such as an RN16) of the second communication device.

(22) A length of to-be-transmitted data, that is, a length of data that needs to be transmitted by the second communication device and that is indicated by the second communication device to the first communication device by using a second response, so that the first communication device learns a state of the to-be-transmitted data on the second communication device, and indicates a resource position and the like.

(23) A supported communication mode, that is, a communication mode such as TDM, FDM, or CDM that is supported by the second communication device and that is indicated by the second communication device to the first communication device by using the second response, so that the first communication device accurately receives subsequent communication data.

(24) Supported communication resources or resource granularity, that is, a communication resource or resource granularity that is supported by the second communication device for use and that is indicated by the second communication device to the first communication device by using the second response, so that the first communication device accurately indicates the transmission resource.

(25) Priority-related information. The priority-related information is used to assist the first communication device in determining, in an inventory process, a second communication device for which transmission is preferentially performed, a second communication device for which transmission is later performed, and the like during subsequent transmission.

Optionally, the priority-related information may be but is not limited to a service category, a device category, whether data is urgent, a data urgency degree, and the like. Correspondingly, the first communication device may determine, based on the service category, the device category, whether data is urgent, the data urgency degree, and the like, whether transmission is preferentially performed for the second communication device and a transmission order.

(26) Quality of service (QoS)-related information. The quality of service related information is used to assist the first communication device in determining, in an inventory process, a second communication device for which transmission is preferentially performed, a second communication device for which transmission is later performed, and the like during subsequent transmission.

Optionally, the quality of service related information may include but is not limited to a QoS identifier of 5G NR (5QI) or a QoS flow identifier (QFI), and may include a rate requirement, a delay requirement, a packet loss rate, an allowable maximum delay budget of a data packet (Packet Delay Budget), BLER (Block Error Rate), a maximum transmission rate (MBR), a communication range, and the like.

Optionally, in addition to the information in (21) to (26) above, the first response may further include more or less information than the information described above, which is not limited herein.

In addition, the first response may alternatively be transmitted by using any one of dedicated signaling, a system message, RRC signaling, a MAC CE, DCI, UCI, SCI, and a physical frame preamble.

It should be noted that, it is considered that during non-orthogonal transmission, if a conflict occurs on a plurality of first responses that are received by the first communication device and that are sent by two or more second communication devices based on a same transmission resource, the first communication device may perform conflict recovery on a conflict first response based on a predetermined conflict signal recovery technology, and then decode and analyze the first response after the conflict recovery, so as to generate a second command used to reply to the first response.

It may be understood that the foregoing “conflict signal recovery technology” may be a zero forcing method that relies only on an IQ signal feature, a conflict signal recovery technology that uses encoding memorability, a conflict signal recovery technology that combines an IQ signal feature with time domain dynamics, or the like. However, for the conflict signal recovery technology that uses encoding memorability and the conflict signal recovery technology that combines an IQ signal feature with time domain dynamics, data packets sent by the second communication devices need to be equal in length, and are synchronous at a data packet level. Otherwise, a second communication device that joins or leaves in transit causes a superimposed signal to change irregularly, making it difficult to ensure demodulation performance and affecting a conflict recovery effect.

For example, when the first communication device performs conflict recovery on two or more pieces of received communication data (for example, the first response) based on the conflict signal recovery technology, to-be-transmitted data on different second communication devices may have different lengths. However, the conflict signal recovery technology requires that a quantity of devices should not be changed when one data packet (for example, the first response) is demodulated. Therefore, before sending the to-be-transmitted data, the second communication devices may perform the following operation 1 or operation 2 on the to-be-transmitted data to ensure that the to-be-transmitted data has a same length.

Operation 1: Padding processing is performed on a short data packet, so that a length of the padded data reaches a predetermined value. For example, the data packet is padded with random data, or existing data is repeated in a specific manner. The predetermined value may be determined based on a longest data packet. For example, the predetermined value is a length value of the longest data packet. The longest data packet is a longest data packet among data packets corresponding to one or more second communication devices that are completed first in an inventory process.

Operation 2: Truncation processing is performed on a long data packet, so that a length of the truncated data reaches a predetermined value. The predetermined value may be determined based on a shortest data packet. For example, the predetermined value is a length value of the shortest data packet. The shortest data packet is a shortest data packet among data packets corresponding to one or more second communication devices that are completed first in an inventory process.

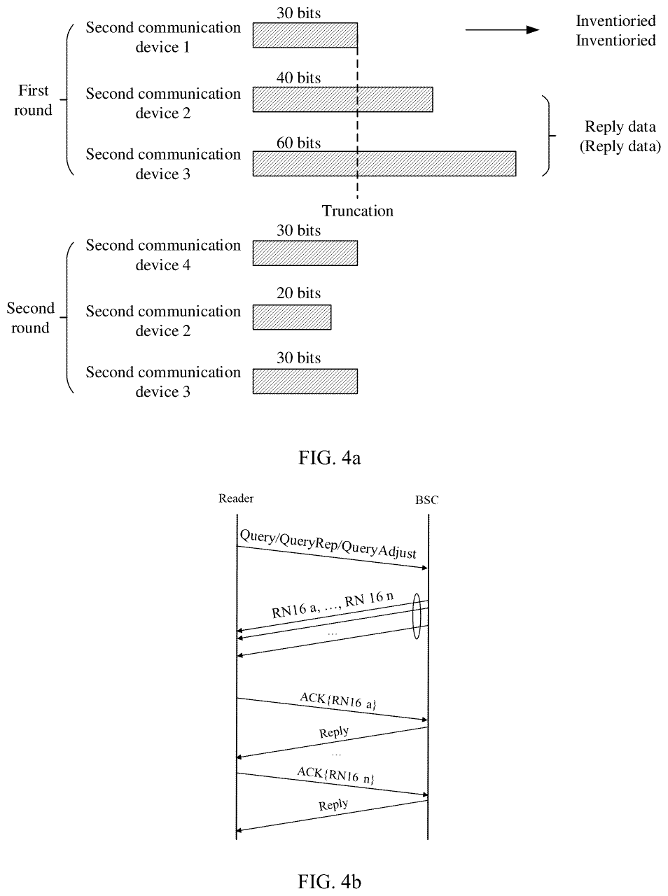

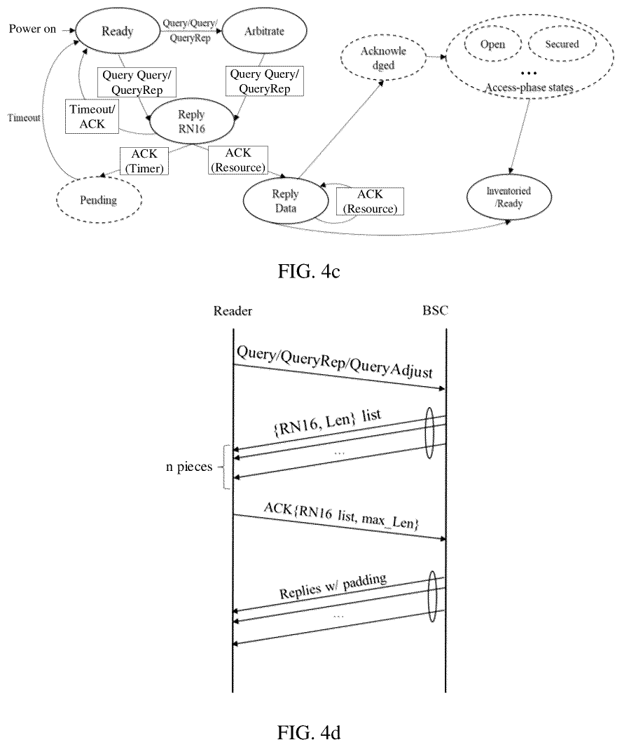

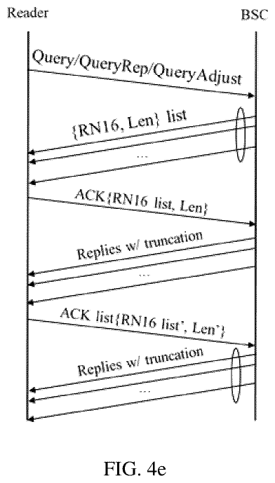

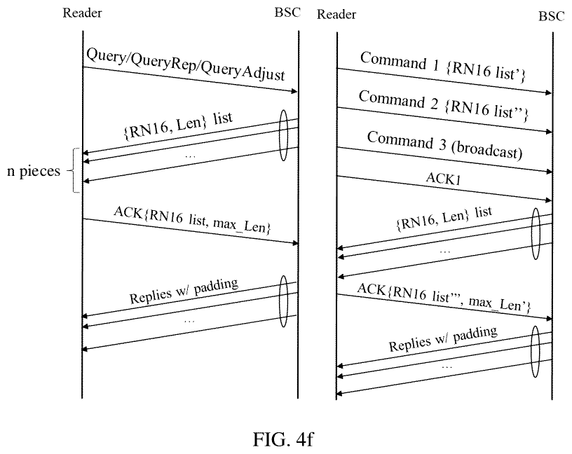

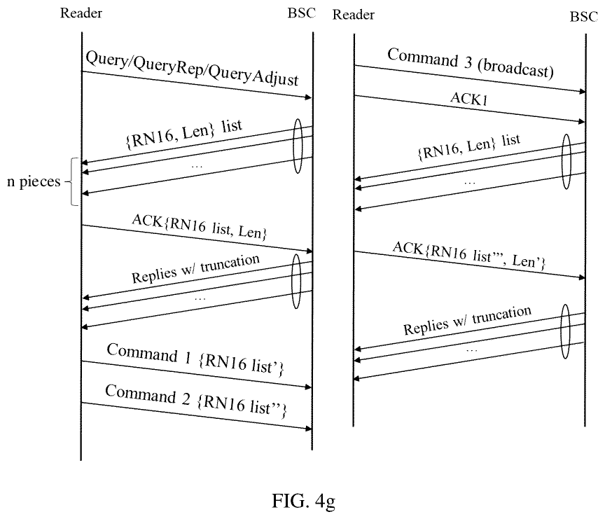

It may be understood that, as shown in FIG. 4a, the foregoing “truncation processing” may be understood as follows: When lengths of data packets that need to be sent by a plurality of second communication devices are inconsistent, truncation may be performed by using the shortest data packet as a reference. In this case, communication performed by at least one second communication device may be completed first, and then a new second communication device is added to a communication process. The foregoing steps may be iterated to complete communication performed by all second communication devices. FIG. 4a shows a process of two rounds of iteration.

S313: The first communication device sends a second command to at least one of the second communication devices.

After receiving one or more first responses sent by the foregoing one or more second communication devices, the first communication device may perform multi-thread decoding on the one or more first responses, and further determine, based on a decoding result, a second command that is used to reply to the first responses. For example, in a case of decoding success, the second command may carry acknowledge (ACK) information. Otherwise, the second command may carry non-acknowledge (NACK) information.

In this embodiment, through interaction between the first response and the second command, the first communication device may further negotiate with two or more second communication devices about a parameter required for sending other communication data except the first response, such as an amount of to-be-transmitted data that needs to be reported by the second communication device, a data amount (or a resource quantity) that the first communication device indicates the second communication device to send at one single time, and a resource position that the first communication device indicates the second communication device to send communication data.

On this basis, in a possible implementation, the second command includes or indicates at least one of (301) to (315) below.

(301) An identifier list of first devices, where a device corresponding to each identifier (such as a device identifier or a temporary identifier) in the identifier list of the first devices is successfully decoded and allowed for data transmission. In other words, the first communication device may indicate, by using the identifier list of first devices, that the corresponding second communication device is successfully decoded, and performs subsequent communication.

(302) An orthogonal transmission resource position list, where the orthogonal transmission resource position list corresponds to the identifier list of first devices. For example, orthogonal transmission resources in the orthogonal transmission resource position list are in a one-to-one correspondence with the identifiers in the identifier list of first devices, so as to be used by second communication devices corresponding to the identifier list of first devices to perform subsequent transmission.

Optionally, the orthogonal transmission resource may be but is not limited to a time domain resource (for example, a timeslot), a frequency, an orthogonal code, or the like.

(303) A quantity of orthogonal transmission resources.

(304) An amount of transmissible data on an orthogonal transmission resource.

(305) An identifier list of second devices, where a device corresponding to each identifier in the identifier list of the second devices is successfully decoded but needs to wait for transmission.

(306) A target timer (which may also be referred to as a waiting timer), where the target timer is related to a second communication device that needs to enter a pending state. For example, the target timer is specially configured for the second communication device that enters the pending state. It is considered that after the first communication device fails to successfully decode a first response sent by a specific second communication device, the second communication device may be always in a pending state, causing an inventory process to be stuck. In view of this, in this application, a target timer is configured for the second communication device that enters the pending state, so that when the target timer times out, the second communication device that enters the pending state determines that the first communication device cannot decode the first response or recover a signal. In other words, contention channel access fails.

It may be understood that a communication time between the first communication device and a specific second communication device may be unfixed. In addition, due to existence of a multi-thread inventory process, a target timer of another second communication device may time out unnecessarily. Therefore, in this application, a target timer may be dynamically indicated to another second communication device, so as to prevent a timeout.

Optionally, the target timer may be configured together with or separately from the identifier list of first devices, which is not limited herein.

(307) A second identifier, used to notify a second communication device that completes the inventory process to enter a silent state, and wake up the second communication device in the pending state to start transmission.

The second identifier may be a device identifier or a temporary identifier of the second communication device, which is not limited herein.

(308) Second synchronization information, used to align a time of each of the second communication devices. For example, the second synchronization information may be used to align a time at which each of the second communication devices processes or waits to process communication data, or a time at which communication data (for example, a command or signaling) is sent to the first communication device, which is not limited herein.

Optionally, the synchronization information may be a preamble, a TA offset, or the like. In this embodiment, the second synchronization information may alternatively be synchronization at a data packet level. For example, the second communication devices simultaneously send second responses to the first communication device based on a same transmission resource.

(309) A resource granularity of a transmission resource used for communication data transmission.

The resource granularity may be but is not limited to a frequency domain network (such as a total bandwidth or a channel bandwidth) or a time domain network (such as a frame length or a timeslot length).

(310) Modulation-related information of a second signal, where the modulation-related information of the second signal includes a modulation scheme or a modulation order. In other words, the signal modulation-related information is used to indicate a modulation scheme or a modulation order used when the second communication device sends communication data.

(311) A length of to-be-transmitted data, used to indicate a data amount sent by the second communication device at one single time.

(312) A data padding type in the to-be-transmitted data. The data padding type may be random padding, repeated padding, or the like. That is, when the second communication device needs to perform padding processing on to-be-transmitted data, padding processing may be performed based on a data padding type indicated in the second command.

(313) A second rate or a second rate offset, used to indicate a rate or a rate offset with which the second communication device sends first communication data.

It should be noted that, considering that data other than the first response is easily transmitted in batches through scheduling, a transmission rate may be appropriately increased, that is, the second rate may be higher than the first rate.

In addition, for different second communication devices, the second rates may be the same or different. However, in different cases, the second command may further include a first rate bias.

(314) A second start time or a second start time offset, used to indicate a start time or a start time offset with which the second communication device sends communication data.

A value of the second start time or the second start time offset may be determined according to a conflict signal recovery technology used when the first communication device processes a plurality of pieces of conflict communication data.

It may be understood that, in this embodiment, each of the second communication devices may be bit-level synchronization (that is, synchronous execution of an inventory process) or bit-level asynchronization (that is, asynchronous execution of an inventory process). In a case of synchronization, the first communication device may indicate a start time to each of the second communication devices by using first signaling. In a case of asynchronization, the first communication device may indicate different start time offsets to the second communication devices respectively by using first signaling, which is not limited herein.

(315) Configuration information of a second reference bit, where the reference bit is used by the first communication device to decode the received communication data sent by the second communication device. In this embodiment, the configuration information includes a position or a length of the reference bit.

It should be noted that the second command may be further used to trigger transmission of application data. However, for different second communication devices, parameters corresponding to the second communication devices may be different, or a receiving object of the second command may be the same as or different from a receiving object of the first command. Therefore, in different cases, the second command may further include these different parameters, such as the first rate or the first rate bias, the start time or the start time bias, the signal modulation-related information, and the configuration information of the reference bit.

In addition, in addition to the information in (301) to (315) above, the second command may further include more or less information than the information described above, which is not limited herein.

In addition, according to different inventory scenarios such as synchronization or asynchronization, the second command may be sent in a manner of a broadcast command or a unicast command. Certainly, if the second command is sent by using a unicast command, the unicast command may further carry a device identifier or a temporary identifier of a corresponding second communication device, in order for each second communication device to accurately identify the corresponding command.

On this basis, in a possible implementation, in addition to the foregoing transmission manner of a unicast command or a broadcast command, the first command may alternatively be transmitted by using any one of dedicated signaling, a system message, RRC signaling, a MAC CE, DCI, UCI, SCI, and a preamble.

In another possible implementation, the first command may be scrambled by using a part or all of the first identifier to ensure security of the transmission, and may further indicate that the second command is configured for a specific second communication device. For example, only the second communication device that has sent the first response can successfully decode the second command.

S314: The first communication device receives a second response sent by each of the second communication devices.

After receiving the second command, the second communication device may determine whether the second command is valid. For example, when the first identifier carried in the second command is the same as the identifier of the second communication device, the second communication device may determine that the second command is valid. In this case, the second communication device may send a second response to the first communication device on a specified resource according to the second command, so as to respond to the second command.

Optionally, the second response may include or indicate at least one of (41) to (43) below.

(41) To-be-transmitted data, for example, factory numbers such as a PC number, XPC, and an EPC.

(42) Padded first to-be-transmitted data. It may be understood that in a case that the second communication device performs padding processing on the first to-be-transmitted data, the second response may include the “padded first to-be-transmitted data”.

(43) Truncated first to-be-transmitted data. It may be understood that in a case that the second communication device performs truncation processing on the first to-be-transmitted data, the second response may include the “truncated first to-be-transmitted data”.

It should be noted that in this embodiment, in addition to the foregoing first command and the foregoing second command, in a possible implementation, in a process in which the first communication device takes inventory of at least two second communication devices based on a multi-thread inventory process, the first communication device sends at least one third command other than the first command and the second command to the second communication device, so as to re-indicate different parameters in different inventory phases. The third command may be but is not limited to a write command, a read command, a random number request (Req_RN), or the like, and the third command may include or indicate at least one of (51) to (56) below.

(51) A waiting time, where the waiting time is used to update timing duration of the target timer, so as to prevent an unnecessary timeout of the target timer. For example, if the first communication device detects that communication with some second communication devices is required, a waiting time of another second communication device in a pending state may be increased to prevent unnecessary communication failure due to a timeout.

(52) A length of to-be-transmitted data and a data padding type in the to-be-transmitted data, used to indicate a length and a data padding type of the to-be-transmitted data during subsequent data transmission of the second communication device. The data padding type includes a random padding type or a repeated padding type.

(53) A third rate or a third rate offset.

(54) Third synchronization information, used to align a time of each of the second communication devices.

(55) A third start time or a third start time offset.

(56) Configuration information of a third reference bit.

It should be noted that, considering that the third command and the second command trigger different transmission phases, for different transmission phases, re-indication may be performed by using the third command. In other words, information in the third command is used to re-indicate different parameters in different inventory phases. For a function of the information in (53) to (56) above, reference may be made to the related descriptions in the foregoing first command and the foregoing second command. Details are not described herein again.

Corresponding to the foregoing third command, in another possible implementation, the at least one third response (such as Write, Read, and Req_RN) other than the first response and the second response that is sent by the second communication device and that is received by the first communication device may include or indicate at least one of (61) to (64) below.

(61) The length of the to-be-transmitted data.

(62) Second to-be-transmitted data.

(63) Truncated second to-be-transmitted data.

(64) Padded second to-be-transmitted data.

It should be noted that the foregoing third command or the foregoing third response may be transmitted by using at least one of dedicated signaling, a system message, RRC signaling, a MAC CE, DCI, UCI, SCI, or a physical frame preamble.

In comparison with “single-thread” inventory, in this embodiment of this application, based on a conflict signal recovery method that may be used by the first communication device, a “multi-thread” inventory process is provided. That is, the first communication device is allowed to take inventory of a plurality of second communication devices in parallel. Therefore, a communication throughput can be significantly increased, and signaling overheads can be reduced. Especially when a quantity of second communication devices is relatively large, inventory efficiency can be significantly improved.

For ease of understanding, based on the foregoing descriptions of the method embodiment 200-300, the following describes, by way of example with reference to Example 1 to Example 6, several different multi-thread inventory processes provided in this application. Content is as follows. It is assumed that the first communication device is a reader/writer (Reader), the second communication device is a BSC device (BSC for short), and the first communication device performs conflict recovery on the received conflict first response based on a conflict signal recovery technology. For the same example, the same information in different commands or responses may be the same or different, which is not limited herein.

### Example 1

It is assumed that the multi-thread inventory process is that at least two second communication devices synchronously perform the inventory process, and perform communication data transmission in the inventory process based on an orthogonal transmission resource. In this case, as shown in FIG. 4b, the inventory process provided in this embodiment is as follows.

S411: The reader/writer sends a first command such as Query, QueryRe, or QueryAdjust shown in FIG. 4b to two or more BSC devices in an orthogonal transmission manner and in a broadcast manner, to indicate or trigger the two or more BSC devices to contend for a channel. In other words, the first command takes effect for all BSC devices.

Optionally, the first command may include or indicate at least one of (a) to (f) below.

(a) Synchronization information, used to align a time of each of the BSC devices.

(b) A first rate or a first rate offset, used to indicate a rate or a rate offset with which each of the BSC devices sends a first response (which may also be referred to as a contention channel data packet).

(c) A start time or a start time offset, used to indicate a start time or a start time offset with which each of the BSC devices sends communication data.

(d) Configuration information of a reference bit, where the configuration information includes a position or a length of the reference bit.

(e) Signal modulation-related information, where the signal modulation-related information includes a modulation scheme or a modulation order.

(f) A length of a first identifier, indicating a length of a first identifier used when the second communication device replies to the first response.

S412: After receiving the first command, each BSC device may send a first response (such as RN16a shown in FIG. 4b) to the first communication device by using a non-orthogonal transmission resource. However, for other communication data except the first response, all the BSC devices may perform transmission based on the orthogonal transmission resource, for example, TDM shown in FIG. 4b. Certainly, transmission of FDM and CDM is similar to that of TDM, and details are not described herein again.

Optionally, the first response may carry at least one of (a) to (f) below.

(a) The first identifier, where the first identifier includes the device identifier or the temporary identifier of the second communication device, so as to be used by the first communication device to uniquely determine a sender of the first response.

(b) A length of to-be-transmitted data, that is, a length of data that needs to be subsequently transmitted by the second communication device and that is indicated by the second communication device to the first communication device by using a second response.

(c) A supported communication mode, that is, a communication mode such as TDM, FDM, or CDM that is supported by the second communication device and that is indicated by the second communication device to the first communication device by using the second response.

(d) Supported communication resources or resource granularity, that is, a communication resource or resource granularity that is supported by the second communication device for use and that is indicated by the second communication device to the first communication device by using the second response.

(e) Priority-related information.

(f) Quality of service related information.

S413: After receiving the first response sent by each BSC device, the reader/writer may perform conflict signal recovery and parsing on each first response according to a conflict signal recovery technology, and separately send a second command such as ACK information or NACK information to the BSC devices in a unicast manner based on a parsing result.

Assuming that the second command is ACK information shown in FIG. 4b, the second command may carry at least one of (a) to (g) below.

(a) An identifier list of first devices, where a device corresponding to each identifier (such as a device identifier or a temporary identifier) in the identifier list of the first devices is successfully decoded and allowed for data transmission.

(b) An orthogonal transmission resource position list, where the orthogonal transmission resource position list corresponds to the identifier list of first devices.

(c) A quantity of orthogonal transmission resources.

(d) An amount of transmissible data on an orthogonal transmission resource.

(e) An identifier list of second devices, where a device corresponding to each identifier in the identifier list of the second devices is successfully decoded but needs to wait for transmission.

(f) A target timer, where the target timer is related to a second communication device that needs to enter a pending state. For example, the target timer is specially configured for the second communication device that enters the pending state. It is considered that after the first communication device fails to successfully decode a first response sent by the second communication device, the second communication device may be always in a pending state, causing an inventory process to be stuck. In view of this, in this application, a target timer is configured for the second communication device that enters the pending state, so that when the target timer times out, it is determined that the first communication device cannot perform decoding or recover a signal. In other words, access fails.

It may be understood that a communication time between the first communication device and a specific second communication device may be unfixed. Due to existence of a plurality of threads, a timer of another second communication device may time out unnecessarily. Therefore, in this application, a target timer may be dynamically indicated to another second communication device, so as to prevent a timeout.

Optionally, the target timer may be configured together with or separately from the identifier list of first devices, which is not limited herein.

(g) A second identifier, used to notify a second communication device that completes the inventory process to enter a silent state, and wake up the second communication device in the pending state to start transmission.

The second identifier may be a device identifier or a temporary identifier of the second communication device, which is not limited herein.

(h) Synchronization information, used to align a time of each of the second communication devices. For example, the synchronization information may be used to align a time at which each of the second communication devices sends a second response (for example, a Reply shown in FIG. 4b).

Optionally, the synchronization information may be a preamble, a TA offset, or the like. In this embodiment, the synchronization information may alternatively be synchronization at a data packet level. For example, the second communication devices simultaneously send second responses to the first communication device based on a same transmission resource.

(i) A resource granularity of a transmission resource used for communication data transmission.

The resource granularity may be but is not limited to a frequency domain network (such as a total bandwidth or a channel bandwidth) or a time domain network (such as a frame length or a timeslot length).

(j) Signal modulation-related information, where the signal modulation-related information includes a modulation scheme or a modulation order.

S414: After receiving and successfully decoding the second command, the BSC device may send a second response, for example, a Reply shown in FIG. 4b, to the reader/writer on a specified resource. The second response may carry to-be-transmitted data (for example, a PC, an EPC, and XPC), so that the reader/writer takes inventory of the BSC device.

Certainly, in addition to the foregoing first command and the foregoing second command, another subsequent third command used in the multi-thread inventory process may also carry a waiting time, so as to update the target timer indicated by the second command, thereby avoiding an unnecessary timeout of the target timer, and the like.

Correspondingly, in addition to the foregoing first response and the foregoing second response, another subsequent response sent by a BSC device in the inventory process may also carry to-be-transmitted data or a length of the to-be-transmitted data, in order for the reader/writer to take inventory, perform a subsequent resource indication, and so on.

In the foregoing implementation process, a state machine of the BSC device may be shown in FIG. 4c, where power-on shown in FIG. 4c is an initial state of the BSC device, and the BSC device finally uses ready or inventoried as an end state.

It may be understood that a state corresponding to a dashed line box shown in FIG. 4c is an optional state, and the state machine of the BSC device provided in this embodiment of this application differs from a state machine of a BSC device in a single-thread inventory process in that a pending state (for example, a state in which the BSC device runs a target timer) and a reply data state (for example, a state in which the BSC device sends a first response and a second response) are added.

It may be understood that, in FIG. 4c, when receiving a first command (such as Query, QueryRep, or QueryAdjust), the BSC device enters an RN16 reply state from the Ready state to reply to the first response, or enters an arbitrate state from the Ready state. where:

If the BSC device enters the Reply RN16 state, when receiving the second command (such as ACK information), the BSC device enters the reply data state, so as to send a second response, or enters the pending state based on a target timer in the second command (such as ACK information), and enters the Ready state again when the target timer times out, or runs the target timer in the second command (such as ACK information), and enters the Ready state again when the target timer times out.

If the BSC device enters the Arbitrate state, the BSC device may enter the Reply RN16 state when receiving the first command (such as Query, QueryRep, or QueryAdjust) again.

If the BSC device enters the Reply data state, the BSC device may send repeated data based on the ACK information received again, or may enter the Inventoried state or the Ready state after sending of the second response is completed, or may enter an acknowledged state. That is, the reader/writer acknowledges that the data sent by the BSC device is complete.

If the BSC device enters the Acknowledged state, the BSC device may enter an access phase state from the Acknowledged state, so as to indicate and trigger the BSC device to send other data or enter a phase of a special operation. This phase includes an encryption and authentication operation. If authentication succeeds, the BSC device enters a “secured state”, or otherwise, enters an “open state”. An operation that can be performed in each state may vary.

It should be noted that the foregoing implementation process provided in Example 1 has a same or corresponding technical feature as the foregoing method embodiment 200 or 300. Therefore, for related descriptions in the foregoing Example 1, reference may be made to related descriptions in the foregoing method embodiment 200-300, and same or corresponding technical effects are achieved. To avoid repetition, details are not described herein again.

### Example 2

It is assumed that the multi-thread inventory process is that at least two second communication devices synchronously perform the inventory process, and perform communication data transmission in the inventory process based on a non-orthogonal transmission resource. In this case, as shown in FIG. 4d, the multi-thread inventory process provided in this embodiment is as follows. It is assumed that for a scenario in which a length of to-be-transmitted data of the BSC device varies, padding processing (for example, padding random data or repeating existing data in a specific manner) is performed on short data by using a longest data packet as a reference, so as to meet a requirement of a conflict signal recovery technology. It should be noted that a quantity of BSC devices cannot be changed during demodulation of a data packet.

S421: The reader/writer sends a first command such as Query, QueryRep, or QueryAdjust shown in FIG. 4d to two or more BSC devices in an orthogonal transmission manner and in a broadcast manner, to indicate or trigger the two or more BSC devices to contend for a channel. In other words, the first command takes effect for all BSC devices.

Optionally, the first command may include or indicate at least one of (a) to (f) below.

(a) Synchronization information, used to align a time of each of the second communication devices.

(b) A first rate or a first rate offset, used to indicate a rate or a rate offset with which the second communication device sends first communication data.

(c) A start time or a start time offset, used to indicate a start time or a start time offset with which the second communication device sends communication data.

(d) Configuration information of a reference bit, where the configuration information includes a position or a length of the reference bit.

(e) Signal modulation-related information, where the signal modulation-related information includes a modulation scheme or a modulation order. In other words, the signal modulation-related information is used to indicate a modulation scheme or a modulation order used when the second communication device sends communication data.

(f) A length of a first identifier, indicating a length of a first identifier used when the BSC device replies to the first response.

S422: After receiving the first command, each BSC device may send, to the reader/writer by using a non-orthogonal transmission resource, a first response (for example, {RN16, Len} list in FIG. 4d) and other communication data except the first response, for example, TDM shown in FIG. 4d. Certainly, transmission of FDM and CDM is similar to that of TDM.

Optionally, the first response may carry at least one of (a) to (f) below.

(a) The first identifier, where the first identifier includes the device identifier or the temporary identifier of the second communication device.

(b) A length of to-be-transmitted data, that is, a length of data that needs to be transmitted by the second communication device and that is indicated by the second communication device to the first communication device by using a second response.

(c) Priority-related information.

(d) Quality of service related information.

S423: After receiving the first response sent by each BSC device, the reader/writer may perform conflict recovery and parsing on each first response according to a conflict signal recovery technology, and send a second command such as ACK information shown in FIG. 4d to the BSC device based on a parsing result.

The second command may carry at least one of (a) to (k) below.

(a) An identifier list of first devices, where a device corresponding to each identifier (such as a device identifier or a temporary identifier) in the identifier list of first devices is successfully decoded and allowed for data transmission.

(b) An identifier list of second devices, where a device corresponding to each identifier in the identifier list of the second devices is successfully decoded but needs to wait for transmission.

(c) A target timer, where the target timer is related to a second communication device that needs to enter a pending state. For example, the target timer is specially configured for the second communication device that enters the pending state. It is considered that after the first communication device fails to successfully decode a first response sent by the second communication device, the second communication device may be always in a pending state, causing an inventory process to be stuck. In view of this, in this application, a target timer is configured for the second communication device that enters the pending state, so that when the target timer times out, it is determined that the first communication device cannot perform decoding or recover a signal. In other words, access fails.

It may be understood that a communication time between the first communication device or the reader/writer and a specific second communication device may be unfixed. Due to existence of a plurality of threads, a timer of another second communication device may time out unnecessarily. Therefore, in this application, a target timer may be dynamically indicated to another second communication device, so as to prevent a timeout.

Optionally, the target timer may be configured together with or separately from the identifier list of first devices, which is not limited herein.

(d) A second identifier, used to notify a second communication device that completes the inventory process to enter a silent state, and wake up the second communication device in the pending state to start transmission.

The second identifier may be a device identifier or a temporary identifier of the second communication device, which is not limited herein.

(e) Synchronization information, used to align a time of each of the second communication devices. For example, the synchronization information may be used to align a time at which each of the second communication devices processes or waits to process communication data, or a time at which communication data (for example, a command or signaling) is sent to the first communication device, which is not limited herein.

Optionally, the synchronization information may be a preamble, a TA offset, or the like. In this embodiment, the synchronization information may alternatively be synchronization at a data packet level. For example, the second communication devices simultaneously send second responses to the first communication device based on a same transmission resource.

(f) Signal modulation-related information, where the signal modulation-related information includes a modulation scheme or a modulation order. In other words, the signal modulation-related information is used to indicate a modulation scheme or a modulation order used when the second communication device sends communication data.

(g) A length of to-be-transmitted data.

(h) A data padding type in the to-be-transmitted data. The data padding type may be random padding, repeated padding, or the like.

(i) A first rate or a first rate offset, used to indicate a rate or a rate offset with which the second communication device sends a second response.

(j) A start time or a start time offset, used to indicate a start time or a start time offset with which the second communication device sends communication data.

(k) Configuration information of a reference bit, where the reference bit is used by the first communication device to decode the received communication data sent by the second communication device. In this embodiment, the configuration information includes a position or a length of the reference bit.

S424: After receiving and successfully decoding the second command, each BSC device may send a second response (for example, Replies w/padding shown in FIG. 4d) to the reader/writer on a specified resource. The second response may carry padded to-be-transmitted data and the like.

Certainly, in addition to the foregoing first command and the foregoing second command, another subsequent third command in the inventory process may also carry at least one of the following:

(a) A waiting time, so as to update the target timer indicated by the second command, thereby avoiding an unnecessary timeout of the target timer, and the like.

(b) A length of to-be-transmitted data and a data padding type in the to-be-transmitted data. The data padding type includes a random padding type or a repeated padding type.

(c) A first rate or a first rate offset.

(d) Synchronization information, used to align a time of each of the second communication devices.

(e) Configuration information of a reference bit.

Correspondingly, in addition to the foregoing first response and the foregoing second response, another subsequent third response sent by a BSC device in the inventory process may also carry to-be-transmitted data, a length of the to-be-transmitted data, padded to-be-transmitted data, and truncated to-be-transmitted data, in order for the reader/writer to take inventory, perform a subsequent resource indication, and so on.

In the foregoing implementation process, a state machine of the BSC device may be shown in FIG. 4c, and details are not described again.

It should be noted that the foregoing implementation process provided in Example 2 has a same or corresponding technical feature as the foregoing method embodiment 200 or 300. Therefore, for related descriptions in the foregoing Example 1, reference may be made to related descriptions in the foregoing method embodiment 200-300, and same or corresponding technical effects are achieved. To avoid repetition, details are not described herein again.

### Example 3

It is assumed that the multi-thread inventory process is that at least two second communication devices synchronously perform the inventory process, and perform communication data transmission in the inventory process based on a non-orthogonal transmission resource. In this case, as shown in FIG. 4e, the multi-thread inventory process provided in this embodiment is as follows. It is assumed that for a scenario in which a length of to-be-transmitted data of the BSC device varies, a long data packet is truncated by using a shortest data packet as a reference, and the data packet is transmitted in segments for a plurality of times, so as to meet a requirement of a conflict signal recovery technology. It should be noted that a quantity of BSC devices cannot be changed during demodulation of a data packet.

S431: The reader/writer sends a first command such as Query, QueryRe, or Query Adjust shown in FIG. 4e to two or more BSC devices in an orthogonal transmission manner and in a broadcast manner, to indicate or trigger the two or more BSC devices to contend for a channel. In other words, the first command and the first command take effect for all BSC devices.

Optionally, the first command may include or indicate at least one of (a) to (f) below.

(a) Synchronization information, used to align a time of each of the second communication devices.

(b) A first rate or a first rate offset, used to indicate a rate or a rate offset with which the second communication device sends first communication data.

(c) A start time or a start time offset, used to indicate a start time or a start time offset with which the second communication device sends communication data.

(d) Configuration information of a reference bit, where the configuration information includes a position or a length of the reference bit.

(e) Signal modulation-related information, where the signal modulation-related information includes a modulation scheme or a modulation order. In other words, the signal modulation-related information is used to indicate a modulation scheme or a modulation order used when the second communication device sends communication data.

(f) A length of a first identifier.

S432: After receiving the first command, each BSC device may send, to the first communication device by using a non-orthogonal transmission resource, a first response (for example, {RN16, len} list shown in FIG. 4e) and other communication data except the first response, for example, TDM shown in FIG. 4e. Certainly, transmission of FDM and CDM is similar to that of TDM.

Optionally, the first response may carry at least one of (a) to (f) below.

(a) The first identifier, where the first identifier includes the device identifier or the temporary identifier of the second communication device.

(b) A length of to-be-transmitted data, that is, a length of data that needs to be transmitted by the second communication device and that is indicated by the second communication device to the first communication device by using a second response.

(c) Priority-related information.

(d) Quality of service related information.

S433: After receiving the first response sent by each BSC device, the reader/writer may perform parsing on each first response according to a conflict signal recovery technology, and send a second command such as ACK information shown in FIG. 4e to the BSC device based on a parsing result.

The second command may carry at least one of (a) to (k) below.

(a) An identifier list of first devices, where a device corresponding to each identifier (such as a device identifier or a temporary identifier) in the identifier list of the first devices is successfully decoded and allowed for data transmission.

(b) An identifier list of second devices, where a device corresponding to each identifier in the identifier list of the second devices is successfully decoded but needs to wait for transmission.

(c) A target timer, where the target timer is related to a second communication device that needs to enter a pending state. For example, the target timer is specially configured for the second communication device that enters the pending state. It is considered that after the first communication device fails to successfully decode a first response sent by the second communication device, the second communication device may be always in a pending state, causing an inventory process to be stuck. In view of this, in this application, a target timer is configured for the second communication device that enters the pending state, so that when the target timer times out, it is determined that the first communication device cannot perform decoding or recover a signal. In other words, access fails.

It may be understood that a communication time between the first communication device or the reader/writer and a specific second communication device may be unfixed. Due to existence of a plurality of threads, a timer of another second communication device may time out unnecessarily. Therefore, in this application, a target timer may be dynamically indicated to another second communication device, so as to prevent a timeout.

Optionally, the target timer may be configured together with or separately from the identifier list of first devices, which is not limited herein.

(d) A second identifier, used to notify a second communication device that completes the inventory process to enter a silent state, and wake up the second communication device in the pending state to start transmission.

The second identifier may be a device identifier or a temporary identifier of the second communication device, which is not limited herein.

(e) Synchronization information, used to align a time of each of the second communication devices. For example, the synchronization information may be used to align a time at which each of the second communication devices processes or waits to process communication data, or a time at which communication data (for example, a command or signaling) is sent to the first communication device, which is not limited herein.

Optionally, the synchronization information may be a preamble, a TA offset, or the like. In this embodiment, the synchronization information may alternatively be synchronization at a data packet level. For example, the second communication devices simultaneously send second responses to the first communication device based on a same transmission resource.

(f) Signal modulation-related information, where the signal modulation-related information includes a modulation scheme or a modulation order. In other words, the signal modulation-related information is used to indicate a modulation scheme or a modulation order used when the second communication device sends communication data.

(g) A length of to-be-transmitted data.

(h) A data padding type in the to-be-transmitted data. The data padding type may be random padding, repeated padding, or the like.

(i) A first rate or a first rate offset, used to indicate a rate or a rate offset with which the second communication device sends first communication data.

The first rate may be a symbol rate or a bit rate. Correspondingly, the first rate offset may also be a symbol rate offset or a bit rate offset. In this embodiment, a value of the first rate or the first rate offset may be determined according to a conflict signal recovery technology used when the first communication device processes a plurality of pieces of conflict communication data.

It may be understood that in this embodiment, for different second communication devices, the first rates may be the same or different. However, in different cases, the first command may further include a first rate bias.

(j) A start time or a start time offset, used to indicate a start time or a start time offset with which the second communication device sends communication data.

(k) Configuration information of a reference bit, where the reference bit is used by the first communication device to decode the received communication data sent by the second communication device. In this embodiment, the configuration information includes a position or a length of the reference bit.

The third command may be scrambled by using all or a part of an identifier of the second communication device.

S434: After receiving and successfully decoding the second command, the BSC device may send a second response (for example, Replies w/truncation shown in FIG. 4e) to the reader/writer on a specified resource. The second response may carry truncated to-be-transmitted data and the like.

Certainly, in addition to the foregoing first command and the foregoing second command, another subsequent third command in the inventory process may also carry at least one of (a) to (f) below.

(a) A waiting time, so as to update timing duration of the target timer indicated by the second command, thereby avoiding an unnecessary timeout of the target timer, and the like.

(b) A length of to-be-transmitted data.

(c) A first rate or a first rate offset.

(d) Synchronization information, used to align a time of each of the second communication devices.

(e) A start time or a start time offset.

(f) Configuration information of a reference bit.

Correspondingly, in addition to the foregoing first response and the foregoing second response, another subsequent response sent by a BSC device in the inventory process may also carry to-be-transmitted data, a length of the to-be-transmitted data, and truncated to-be-transmitted data, in order for the reader/writer to take inventory, perform a subsequent resource indication, and so on.

In the foregoing implementation process, a state machine of the BSC device may be shown in FIG. 4c, and details are not described herein again.

It should be noted that the foregoing implementation process provided in Example 3 has a same or corresponding technical feature as the foregoing method embodiment 200 or 300. Therefore, for related descriptions in the foregoing Example 1, reference may be made to related descriptions in the foregoing method embodiment 200-300, and same or corresponding technical effects are achieved. To avoid repetition, details are not described herein again.

### Example 4

It is assumed that the multi-thread inventory process is that at least two second communication devices asynchronously perform the inventory process, and perform communication data transmission in the inventory process based on an orthogonal transmission resource. It is assumed that for a scenario in which a length of to-be-transmitted data of the BSC device varies, padding processing (for example, padding random data or repeating existing data in a specific manner) is performed on short data by using a longest data packet as a reference, so as to meet a requirement of a conflict signal recovery technology, that is, data packets transmitted by the BSC devices need to have a same length.

It may be understood that, as shown in FIG. 4f, an implementation process of Example 4 is similar to an implementation process of Example 2, and a difference therebetween is as follows: In Example 4, different BSC devices may process different commands at a same moment, that is, asynchronously perform an inventory process. Therefore, the reader/writer may respectively send the first command, the second command, the third command, and the like to different BSC devices in a unicast manner. In addition, when the reader/writer demodulates a data packet, a quantity of BSC devices cannot be changed. Therefore, the second command (such as ACK1 shown in FIG. 4f) and the like may be used to trigger data transmission of all BSC devices.

In addition, for the BSC device, control signaling and application data require different transmission rates, which can be dynamically adjusted.

### Example 5

It is assumed that the multi-thread inventory process is that at least two second communication devices asynchronously perform the inventory process, and perform communication data transmission in the inventory process based on an orthogonal transmission resource. It is assumed that for a scenario in which a length of to-be-transmitted data of the BSC device varies, a long data packet is truncated by using a shortest data packet as a reference, and the data packet is transmitted in segments for a plurality of times, so as to meet a requirement of a conflict signal recovery technology, that is, data packets transmitted by the BSC devices need to have a same length.

It may be understood that Example 5 differs from Example 4 in that to-be-transmitted data of a plurality of BSC devices is aligned through truncation instead of padding. Therefore, there may be a case that some BSC devices first finish sending data, but some other BSC devices have not finished sending data. For this reason, in this example, the second command (such as Command 1, Command 2, and Command 3 shown in FIG. 4g) and the like may be used to notify a BSC device that has not completed transmission to continue sending.

### Example 6

It is assumed that the multi-thread inventory process is that at least two second communication devices asynchronously perform the inventory process, and perform communication data transmission in the inventory process based on a non-orthogonal transmission resource.

It should be noted that, Example 6 may basically reuse the implementation process of Example 1. A difference lies in that BSC devices in Example 6 contend for a channel “synchronously”, and subsequent signaling and transmission processes may be all performed “asynchronously”, and a quantity and a position of transmission resources for communication of the BSC devices need to be separately configured for each (per) BSC device.

It may be understood that the inventory process provided in this application may include but is not limited to those shown in Example 1 to Example 6, for example, may include more or fewer steps than those in Example 1 to Example 6, which is not limited herein.

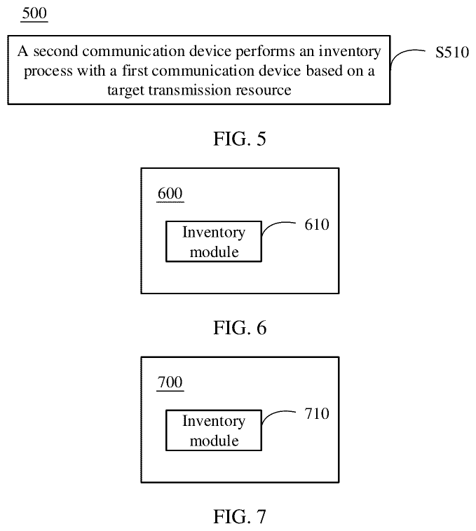

FIG. 5 is a schematic flowchart of an inventory method 500 according to an example embodiment of this application. The method 500 may be performed by but is not limited to a second communication device, and may be performed by hardware or software installed in the second communication device. In this embodiment, the method 500 may include at least the following steps.

S510: The second communication device performs an inventory process with a first communication device.

The inventory process corresponding to the second communication device and an inventory process corresponding to the at least one third communication device belong to a same multi-thread inventory process performed by the first communication device. It may be understood that, for the first communication device in a same multi-thread inventory process, both the second communication device and at least one third communication device may be referred to as a second communication device. In this embodiment, for ease of description, the second communication device is classified into a second communication device and a third communication device for distinguishing. However, for implementation processes of the second communication device and the third communication device, reference may be made to related descriptions in the foregoing method embodiment 200-300, and same or corresponding technical effects are achieved. Details are not described herein again.

Optionally, the multi-thread inventory process includes at least one of the following: The second communication device synchronously performs the inventory process with the at least one third communication device, and performs communication data transmission in the inventory process based on an orthogonal transmission resource; the second communication device synchronously performs the inventory process with the at least one third communication device, and performs communication data transmission in the inventory process based on a non-orthogonal transmission resource; the second communication device asynchronously performs the inventory process with the at least one third communication device, and performs communication data transmission in the inventory process based on an orthogonal transmission resource; or the second communication device asynchronously performs the inventory process with the at least one third communication device, and performs communication data transmission in the inventory process based on a non-orthogonal transmission resource, where the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

Optionally, in the inventory process corresponding to the second communication device, a first command that is received by the second communication device and that is used to indicate or trigger the second communication device to contend for a channel includes or indicates at least one of the following: first synchronization information, used to align a time of each of the second communication devices and a time of the third communication device; a first rate or a first rate offset, used to indicate a rate or a rate offset with which the second communication device sends first communication data; a first start time or a first start time offset, used to indicate a start time or a start time offset with which the second communication device sends communication data; configuration information of a first reference bit, where the configuration information includes a position or a length of the reference bit; modulation-related information of a first signal, where the modulation-related information of the first signal includes a modulation scheme or a modulation order; or a length of a first identifier, where the first identifier includes a device identifier or a temporary identifier of the second communication device.

Optionally, in the inventory process corresponding to the second communication device, a first response that is sent by the second communication device and that is used to respond to the first command includes or indicates at least one of the following: the first identifier, where the first identifier includes the device identifier or the temporary identifier of the second communication device; a length of to-be-transmitted data; a supported communication mode; supported communication resources or resource granularity; priority-related information; or quality of service QoS-related information.

Optionally, in the inventory process corresponding to the second communication device, a second command that is received by the second communication device and that is used to reply to the first response includes or indicates at least one of the following: an identifier list of first devices, where a device corresponding to each identifier in the identifier list of the first devices is successfully decoded and allowed for data transmission; an orthogonal transmission resource position list, where the orthogonal transmission resource position list corresponds to the identifier list of first devices; a quantity of orthogonal transmission resources; an amount of transmissible data on an orthogonal transmission resource; an identifier list of second devices, where a device corresponding to each identifier in the identifier list of the second devices is successfully decoded but needs to wait for transmission; a target timer, where the target timer is related to a second communication device that needs to enter a pending state; a second identifier, used to notify a second communication device that completes the inventory process to enter a silent state, and wake up the second communication device in the pending state to start transmission; second synchronization information, used to align a time of each of the second communication devices and a time of the third communication device; a resource granularity of a transmission resource used for communication data transmission; modulation-related information of a second signal, where the signal modulation-related information includes a modulation scheme or a modulation order; the length of the to-be-transmitted data; a data padding type in the to-be-transmitted data; a second rate or a second rate offset, used to indicate a rate or a rate offset with which the second communication device sends first communication data; a second start time or a second start time offset, used to indicate a start time or a start time offset with which the second communication device sends communication data; or configuration information of a second reference bit, where the configuration information includes a position or a length of the reference bit.

Optionally, in the inventory process corresponding to the second communication device, a second response that is sent by the second communication device and that is used to respond to the second command includes or indicates at least one of the following: first to-be-transmitted data; padded first to-be-transmitted data; or truncated first to-be-transmitted data.

Optionally, the method further includes: in a case that the length of the to-be-transmitted data does not reach or exceeds a predetermined value, performing truncation processing or padding processing on the to-be-transmitted data until the length of the to-be-transmitted data reaches the predetermined value; and determining the second response based on the truncated or padded to-be-transmitted data.

Optionally, at least one third command that is sent by the first communication device and that is received by the second communication device carries at least one of the following: a waiting time, where the waiting time is used to update timing duration of the target timer; the length of the to-be-transmitted data and the data padding type in the to-be-transmitted data; a first rate or a first rate offset; synchronization information, used to align a time of each of the second communication devices and a time of the third communication device; a start time or a start time offset; or configuration information of a reference bit, where the third command is a command other than the first command and the second command in the inventory process corresponding to the second communication device.

Optionally, at least one third response sent by the second communication device to the first communication device includes or indicates at least one of the following: the length of the to-be-transmitted data; second to-be-transmitted data; truncated second to-be-transmitted data; or padded second to-be-transmitted data, where the third response is a response other than the first response and the second response in the inventory process corresponding to the second communication device.

Optionally, the first command or the second command is scrambled by using a part or all of the device identifier.

Optionally, the first command is any one of the following: a broadcast command; and a unicast command, where the unicast command carries the first identifier of the second communication device; or the second command is any one of the following: a broadcast command; and a unicast command, where the unicast command carries the first identifier of the second communication device.

Optionally, target command or a target response is transmitted by using at least one of the following: dedicated signaling, a system message, radio resource control RRC signaling, a medium access control control element MAC CE, downlink control information DCI, uplink control information UCI, sidelink control information SCI, or a physical frame preamble, where the target command includes at least one of the first command, the second command, or the third command, and the target response includes at least one of the first response, the second response, or the third response.

It may be understood that the method embodiment 500 has a same or corresponding technical feature as the foregoing method embodiment 200-300. Therefore, for related descriptions of implementations in the method embodiment 500, reference may be made to related descriptions in the foregoing method embodiment 200-300, and same or corresponding technical effects are achieved. To avoid repetition, details are not described herein again.

The inventory method provided in this embodiment of this application may be performed by an inventory apparatus. In the embodiments of this application, an example in which the inventory apparatus performs the inventory method is used to describe the inventory apparatus provided in the embodiments of this application.

FIG. 6 is a schematic structural diagram of an inventory apparatus 600 according to an embodiment of this application. The apparatus 600 includes an inventory module 610, configured to take inventory of at least two second communication devices based on a multi-thread inventory process.

Optionally, the apparatus 600 further includes a selection module, configured to select the second communication device of which inventory needs to be taken.

Optionally, the multi-thread inventory process includes at least one of the following: At least two second communication devices synchronously perform the inventory process, and perform communication data transmission in the inventory process based on an orthogonal transmission resource; at least two second communication devices synchronously perform the inventory process, and perform communication data transmission in the inventory process based on a non-orthogonal transmission resource; at least two second communication devices asynchronously perform the inventory process, and perform communication data transmission in the inventory process based on an orthogonal transmission resource; or at least two second communication devices asynchronously perform the inventory process, and perform communication data transmission in the inventory process based on a non-orthogonal transmission resource, where the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

Optionally, in a process in which the inventory module 610 takes inventory of at least two second communication devices based on a multi-thread inventory process, a first command that is sent by a transmission module and that is used to indicate or trigger each of the second communication devices to contend for a channel includes or indicates at least one of the following: first synchronization information, used to align a time of each of the second communication devices; a first rate or a first rate offset, used to indicate a rate or a rate offset with which the second communication device sends first communication data; a first start time or a first start time offset, used to indicate a start time or a start time offset with which the second communication device sends communication data; configuration information of a first reference bit, where the configuration information includes a position or a length of the reference bit; modulation-related information of a first signal, where the modulation-related information of the first signal includes a modulation scheme or a modulation order; or a length of a first identifier, where the first identifier includes a device identifier or a temporary identifier of the second communication device.

Optionally, in a process in which the inventory module 610 takes inventory of at least two second communication devices based on a multi-thread inventory process, a first response that is received by a transmission module and that is used to respond to the first command includes or indicates at least one of the following: the first identifier, where the first identifier includes the device identifier or the temporary identifier of the second communication device; a length of to-be-transmitted data; a supported communication mode; supported communication resources or resource granularity; priority-related information; or quality of service QoS-related information.

Optionally, in a process in which the inventory module 610 takes inventory of at least two second communication devices based on a multi-thread inventory process, a second command that is sent by a transmission module and that is used to reply to the first response sent by the second communication device includes or indicates at least one of the following: an identifier list of first devices, where a device corresponding to each identifier in the identifier list of the first devices is successfully decoded and allowed for data transmission; an orthogonal transmission resource position list, where the orthogonal transmission resource position list corresponds to the identifier list of first devices; a quantity of orthogonal transmission resources; an amount of transmissible data on an orthogonal transmission resource; an identifier list of second devices, where a device corresponding to each identifier in the identifier list of the second devices is successfully decoded but needs to wait for transmission; a target timer, where the target timer is related to a second communication device that needs to enter a pending state; a second identifier, used to notify a second communication device that completes the inventory process to enter a silent state, and wake up the second communication device in the pending state to start transmission; second synchronization information, used to align a time of each of the second communication devices; a resource granularity of a transmission resource used for communication data transmission; modulation-related information of a second signal, where the modulation-related information of the second signal includes a modulation scheme or a modulation order; the length of the to-be-transmitted data; a data padding type in the to-be-transmitted data; a second rate or a second rate offset, used to indicate a rate or a rate offset with which the second communication device sends first communication data; a second start time or a second start time offset, used to indicate a start time or a start time offset with which the second communication device sends communication data; or configuration information of a second reference bit, where the configuration information includes a position or a length of the reference bit.

Optionally, in a process in which the inventory module 610 takes inventory of at least two second communication devices based on a multi-thread inventory process, a second response that is received by a transmission module and that is used to respond to the second command includes or indicates at least one of the following: first to-be-transmitted data; padded first to-be-transmitted data; or truncated first to-be-transmitted data.

Optionally, in a process in which the inventory module 610 takes inventory of at least two second communication devices based on a multi-thread inventory process, at least one third command sent by a transmission module to the second communication device includes or indicates at least one of the following: a waiting time, where the waiting time is used to update timing duration of the target timer; the length of the to-be-transmitted data and the data padding type in the to-be-transmitted data; a third rate or a third rate offset; third synchronization information, used to align a time of each of the second communication devices; a third start time or a third start time offset; or configuration information of a third reference bit, where the third command is a command other than the first command and the second command in the multi-thread inventory process.

Optionally, at least one third response that is sent by the second communication device and that is received by the transmission module includes or indicates at least one of the following: the length of the to-be-transmitted data; second to-be-transmitted data; truncated second to-be-transmitted data; or padded second to-be-transmitted data, where the third response is a response other than the first response and the second response in a process in which the first communication device takes inventory of the at least two second communication devices based on the multi-thread inventory process.

Optionally, the method further includes: in a process in which the inventory module 610 takes inventory of the at least two second communication devices based on the multi-thread inventory process, if a plurality of pieces of communication data received by the transmission module conflict, performing conflict recovery processing on the plurality of pieces of communication data based on a predetermined conflict signal recovery technology.

Optionally, the first command or the second command is scrambled by using a part or all of the first identifier, and the first identifier includes the device identifier or the temporary identifier of the second communication device.

Optionally, the first command is any one of the following: a broadcast command; and a unicast command, where the unicast command carries the first identifier of the second communication device; or the second command is any one of the following: a broadcast command; and a unicast command, where the unicast command carries the first identifier of the second communication device.

Optionally, target command or a target response is transmitted by using at least one of the following: dedicated signaling, a system message, radio resource control RRC signaling, a medium access control control element MAC CE, downlink control information DCI, uplink control information UCI, sidelink control information SCI, or a physical frame preamble, where the target command includes at least one of the first command, the second command, or the third command, and the target response includes at least one of the first response, the second response, or the third response.

FIG. 7 is a schematic structural diagram of an inventory apparatus 700 according to an embodiment of this application. The apparatus 700 includes an inventory module. The inventory module is configured to perform an inventory process with a first communication device, where the inventory process corresponding to the second communication device and an inventory process corresponding to at least one third communication device belong to a same multi-thread inventory process performed by the first communication device.

Optionally, the multi-thread inventory process includes at least one of the following: The second communication device synchronously performs the inventory process with the at least one third communication device, and performs communication data transmission in the inventory process based on an orthogonal transmission resource; the second communication device synchronously performs the inventory process with the at least one third communication device, and performs communication data transmission in the inventory process based on a non-orthogonal transmission resource; the second communication device asynchronously performs the inventory process with the at least one third communication device, and performs communication data transmission in the inventory process based on an orthogonal transmission resource; or the second communication device asynchronously performs the inventory process with the at least one third communication device, and performs communication data transmission in the inventory process based on a non-orthogonal transmission resource, where the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

Optionally, in the inventory process corresponding to the second communication device, a first command that is received by the transmission module and that is used to indicate or trigger the second communication device to contend for a channel includes or indicates at least one of the following: first synchronization information, used to align a time of each of the second communication devices and a time of the third communication device; a first rate or a first rate offset, used to indicate a rate or a rate offset with which the second communication device sends first communication data; a first start time or a first start time offset, used to indicate a start time or a start time offset with which the second communication device sends communication data; configuration information of a first reference bit, where the configuration information includes a position or a length of the reference bit; modulation-related information of a first signal, where the modulation-related information of the first signal includes a modulation scheme or a modulation order; or a length of a first identifier, where the first identifier includes a device identifier or a temporary identifier of the second communication device.

Optionally, in the inventory process corresponding to the second communication device, a first response that is sent by the second communication device and that is used to respond to the first command includes or indicates at least one of the following: the first identifier, where the first identifier includes the device identifier or the temporary identifier of the second communication device; a length of to-be-transmitted data; a supported communication mode; supported communication resources or resource granularity; priority-related information; or quality of service QoS-related information.

Optionally, in the inventory process corresponding to the second communication device, a second command that is received by the transmission module and that is used to reply to the first response includes or indicates at least one of the following: an identifier list of first devices, where a device corresponding to each identifier in the identifier list of the first devices is successfully decoded and allowed for data transmission; an orthogonal transmission resource position list, where the orthogonal transmission resource position list corresponds to the identifier list of first devices; a quantity of orthogonal transmission resources; an amount of transmissible data on an orthogonal transmission resource; an identifier list of second devices, where a device corresponding to each identifier in the identifier list of the second devices is successfully decoded but needs to wait for transmission; a target timer, where the target timer is related to a second communication device that needs to enter a pending state; a second identifier, used to notify a second communication device that completes the inventory process to enter a silent state, and wake up the second communication device in the pending state to start transmission; second synchronization information, used to align a time of each of the second communication devices and a time of the third communication device; a resource granularity of a transmission resource used for communication data transmission; modulation-related information of a second signal, where the signal modulation-related information includes a modulation scheme or a modulation order; the length of the to-be-transmitted data; a data padding type in the to-be-transmitted data; a second rate or a second rate offset, used to indicate a rate or a rate offset with which the second communication device sends first communication data; a second start time or a second start time offset, used to indicate a start time or a start time offset with which the second communication device sends communication data; or configuration information of a second reference bit, where the configuration information includes a position or a length of the reference bit.

Optionally, in the inventory process corresponding to the second communication device, a second response that is sent by the second communication device and that is used to respond to the second command includes or indicates at least one of the following: first to-be-transmitted data; padded first to-be-transmitted data; or truncated first to-be-transmitted data.

Optionally, the inventory module is further configured to: in a case that the length of the to-be-transmitted data does not reach or exceeds a predetermined value, perform truncation processing or padding processing on the to-be-transmitted data until the length of the to-be-transmitted data reaches the predetermined value; and determine the second response based on the truncated or padded to-be-transmitted data.

Optionally, at least one third command that is sent by the first communication device and that is received by the transmission module carries at least one of the following: a waiting time, where the waiting time is used to update timing duration of the target timer; the length of the to-be-transmitted data and the data padding type in the to-be-transmitted data; a first rate or a first rate offset; synchronization information, used to align a time of each of the second communication devices and a time of the third communication device; a start time or a start time offset; or configuration information of a reference bit, where the third command is a command other than the first command and the second command in the inventory process corresponding to the second communication device.

Optionally, at least one third response sent by the transmission module to the first communication device includes or indicates at least one of the following: the length of the to-be-transmitted data; second to-be-transmitted data; truncated second to-be-transmitted data; or padded second to-be-transmitted data, where the third response is a response other than the first response and the second response in the inventory process corresponding to the second communication device.

Optionally, the first command or the second command is scrambled by using a part or all of the device identifier.

Optionally, the first command is any one of the following: a broadcast command; and a unicast command, where the unicast command carries the first identifier of the second communication device; or the second command is any one of the following: a broadcast command; and a unicast command, where the unicast command carries the first identifier of the second communication device.

Optionally, target command or a target response is transmitted by using at least one of the following: dedicated signaling, a system message, radio resource control RRC signaling, a medium access control control element MAC CE, downlink control information DCI, uplink control information UCI, sidelink control information SCI, or a physical frame preamble, where the target command includes at least one of the first command, the second command, or the third command, and the target response includes at least one of the first response, the second response, or the third response.

The inventory apparatus 600-700 in this embodiment of this application may be a communication device, for example, a communication device with an operating system, or may be a component such as an integrated circuit or a chip in the communication device. The communication device may be a terminal, or may be a network-side device. For example, the terminal may include but is not limited to the types of the terminal 11 listed above, and the network-side device may include but is not limited to the types of the network-side device 12 listed above.

The inventory apparatus 600-700 provided in this embodiment of this application can implement various processes implemented in the method embodiment of FIG. 2 to FIG. 5, and achieve a same technical effect. To avoid repetition, details are not described herein again.

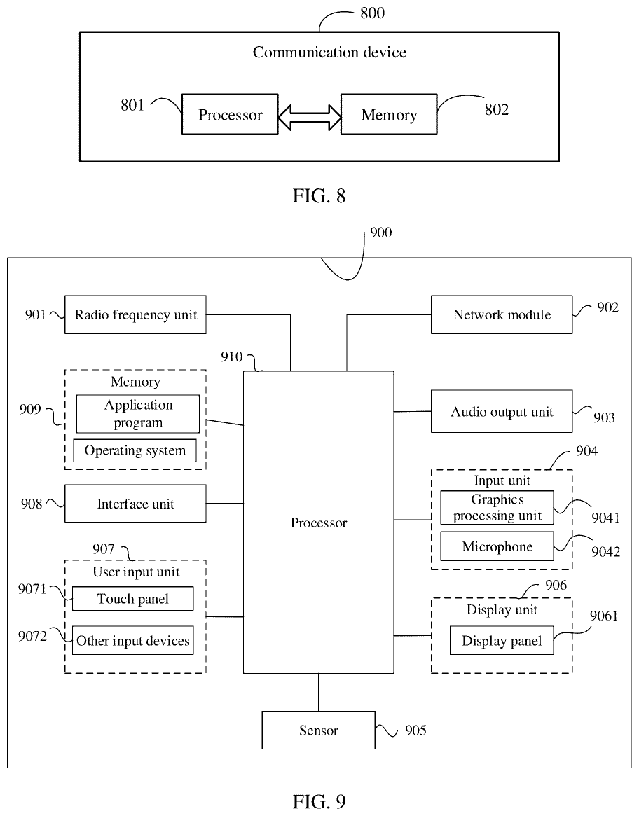

As shown in FIG. 8, an embodiment of this application further provides a communication device 800, including a processor 801 and a memory 802. The memory 802 stores a program or instructions executable on the processor 801. For example, when the communication device 800 is a terminal, the program or the instructions are executed by the processor 801, the steps in the foregoing embodiments of the inventory method are implemented, and same technical effects can be achieved. When the communication device 800 is a network-side device, the program or the instructions are executed by the processor 801, the steps in the foregoing embodiments of the inventory method are implemented, and same technical effects can be achieved. To avoid repetition, details are not described herein again.

An embodiment of this application further provides a terminal, including a processor and a communication interface. The communication interface is coupled to the processor. The processor is configured to run a program or instructions to implement the steps in the method embodiment shown in FIG. 2 to FIG. 5. The terminal embodiment corresponds to the foregoing method embodiment on the first communication device side or the second communication device side. Each implementation process and implementation of the foregoing method embodiment may be applied to the terminal embodiment, and same technical effects can be achieved. For example, FIG. 9 is a schematic diagram of a hardware structure of a terminal for implementing an embodiment of this application.

The terminal 900 includes but is not limited to at least some components of a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that the terminal 900 may further include a power supply (for example, a battery) that supplies power to each component. The power supply may be logically connected to the processor 910 by using a power management system, so as to implement functions such as charging management, discharging management, and power consumption management by using the power management system. The structure of the terminal shown in FIG. 9 does not constitute a limitation on the terminal. The terminal may include more or fewer components than those shown in the figure, or combine some components, or have different component arrangements. Details are not described herein again.

It should be understood that in this embodiment of this application, the input unit 904 may include a graphics processing unit (GPU) 9041 and a microphone 9042. The graphics processing unit 9041 processes image data of a still picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or an on/off key), a trackball, a mouse, or a joystick. Details are not described herein.

In this embodiment of this application, after receiving downlink data from a network-side device, the radio frequency unit 901 may transmit the downlink data to the processor 910 for processing. In addition, the radio frequency unit 901 may send uplink data to the network-side device. Generally, the radio frequency unit 901 includes but is not limited to an antenna, an amplifier, a transceiver, a coupler, a low-noise amplifier, a duplexer, or the like.

The memory 909 may be configured to store a software program or instructions and various types of data. The memory 909 may mainly include a first storage area for storing a program or instructions and a second storage area for storing data. The first storage area may store an operating system, an application program or instructions required by at least one function (for example, a sound playing function or an image playing function), and the like. In addition, the memory 909 may include a volatile memory or a nonvolatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 909 in this embodiment of this application includes but is not limited to these memories and any other suitable type of memory.

The processor 910 may include one or more processing units. Optionally, the processor 910 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 910.

The processor 910 is configured to take inventory of at least two second communication devices based on a multi-thread inventory process.

Optionally, the apparatus 600 further includes a selection module, configured to select the second communication device of which inventory needs to be taken.

Optionally, the multi-thread inventory process includes at least one of the following: At least two second communication devices synchronously perform the inventory process, and perform communication data transmission in the inventory process based on an orthogonal transmission resource; at least two second communication devices synchronously perform the inventory process, and perform communication data transmission in the inventory process based on a non-orthogonal transmission resource; at least two second communication devices asynchronously perform the inventory process, and perform communication data transmission in the inventory process based on an orthogonal transmission resource; or at least two second communication devices asynchronously perform the inventory process, and perform communication data transmission in the inventory process based on a non-orthogonal transmission resource, where the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

Optionally, in a process in which the processor 910 takes inventory of at least two second communication devices based on a multi-thread inventory process, a first command that is sent by a radio frequency unit 901 and that is used to indicate or trigger each of the second communication devices to contend for a channel includes or indicates at least one of the following: first synchronization information, used to align a time of each of the second communication devices; a first rate or a first rate offset, used to indicate a rate or a rate offset with which the second communication device sends first communication data; a first start time or a first start time offset, used to indicate a start time or a start time offset with which the second communication device sends communication data; configuration information of a first reference bit, where the configuration information includes a position or a length of the reference bit; modulation-related information of a first signal, where the modulation-related information of the first signal includes a modulation scheme or a modulation order; or a length of a first identifier, where the first identifier includes a device identifier or a temporary identifier of the second communication device.

Optionally, in a process in which the processor 910 takes inventory of at least two second communication devices based on a multi-thread inventory process, a first response that is received by a radio frequency unit 901 and that is used to respond to the first command includes or indicates at least one of the following: the first identifier, where the first identifier includes the device identifier or the temporary identifier of the second communication device; a length of to-be-transmitted data; a supported communication mode; supported communication resources or resource granularity; priority-related information; or quality of service QoS-related information.

Optionally, in a process in which the processor 910 takes inventory of at least two second communication devices based on a multi-thread inventory process, a second command that is sent by a radio frequency unit 901 and that is used to reply to the first response sent by the second communication device includes or indicates at least one of the following: an identifier list of first devices, where a device corresponding to each identifier in the identifier list of the first devices is successfully decoded and allowed for data transmission; an orthogonal transmission resource position list, where the orthogonal transmission resource position list corresponds to the identifier list of first devices; a quantity of orthogonal transmission resources; an amount of transmissible data on an orthogonal transmission resource; an identifier list of second devices, where a device corresponding to each identifier in the identifier list of the second devices is successfully decoded but needs to wait for transmission; a target timer, where the target timer is related to a second communication device that needs to enter a pending state; a second identifier, used to notify a second communication device that completes the inventory process to enter a silent state, and wake up the second communication device in the pending state to start transmission; second synchronization information, used to align a time of each of the second communication devices; a resource granularity of a transmission resource used for communication data transmission; modulation-related information of a second signal, where the signal modulation-related information includes a modulation scheme or a modulation order; the length of the to-be-transmitted data; a data padding type in the to-be-transmitted data; a second rate or a second rate offset, used to indicate a rate or a rate offset with which the second communication device sends first communication data; a second start time or a second start time offset, used to indicate a start time or a start time offset with which the second communication device sends communication data; or configuration information of a second reference bit, where the configuration information includes a position or a length of the reference bit.

Optionally, in a process in which the processor 910 takes inventory of at least two second communication devices based on a multi-thread inventory process, a second response that is received by a radio frequency unit 901 and that is used to respond to the second command includes or indicates at least one of the following: first to-be-transmitted data; padded first to-be-transmitted data; or truncated first to-be-transmitted data.

Optionally, in a process in which the processor 910 takes inventory of at least two second communication devices based on a multi-thread inventory process, at least one third command sent by a radio frequency unit 901 to the second communication device includes or indicates at least one of the following: a waiting time, where the waiting time is used to update timing duration of the target timer; the length of the to-be-transmitted data and the data padding type in the to-be-transmitted data; a third rate or a third rate offset; third synchronization information, used to align a time of each of the second communication devices; a third start time or a third start time offset; or configuration information of a third reference bit, where the third command is a command other than the first command and the second command in the multi-thread inventory process.

Optionally, at least one third response that is sent by the second communication device and that is received by the radio frequency unit 901 includes or indicates at least one of the following: the length of the to-be-transmitted data; second to-be-transmitted data; truncated second to-be-transmitted data; or padded second to-be-transmitted data, where the third response is a response other than the first response and the second response in a process in which the first communication device takes inventory of the at least two second communication devices based on the multi-thread inventory process.

Optionally, the method further includes: in a process in which the processor 910 takes inventory of the at least two second communication devices based on the multi-thread inventory process, if a plurality of pieces of communication data received by the radio frequency unit 901 conflict, performing conflict recovery processing on the plurality of pieces of communication data based on a predetermined conflict signal recovery technology.

Optionally, the first command or the second command is scrambled by using a part or all of the first identifier, and the first identifier includes the device identifier or the temporary identifier of the second communication device.

Optionally, the first command is any one of the following: a broadcast command; and a unicast command, where the unicast command carries the first identifier of the second communication device; or the second command is any one of the following: a broadcast command; and a unicast command, where the unicast command carries the first identifier of the second communication device.

Optionally, target command or a target response is transmitted by using at least one of the following: dedicated signaling, a system message, radio resource control RRC signaling, a medium access control control element MAC CE, downlink control information DCI, uplink control information UCI, sidelink control information SCI, or a physical frame preamble, where the target command includes at least one of the first command, the second command, or the third command, and the target response includes at least one of the first response, the second response, or the third response.

It may be understood that for implementation processes of the implementations mentioned in this embodiment, reference may be made to related descriptions in the method embodiment 200-500, and same or corresponding technical effects are achieved. To avoid repetition, details are not described herein again.

An embodiment of this application further provides a network-side device, including a processor and a communication interface. The communication interface is coupled to the processor. The processor is configured to run a program or instructions to implement the steps in the method embodiment shown in FIG. 2 to FIG. 5. The network-side device embodiment corresponds to the foregoing method embodiment for the network-side device. Each implementation process and implementation of the foregoing method embodiment may be applied to the network-side device embodiment, and same technical effects can be achieved.

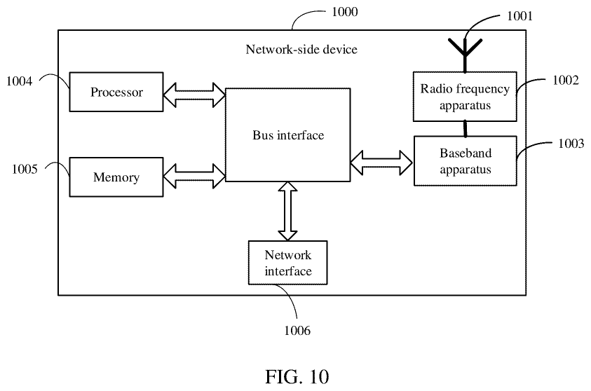

For example, an embodiment of this application further provides a network-side device. As shown in FIG. 10, the network-side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes to-be-sent information, and sends the processed information to the radio frequency apparatus 1002. After processing the received information, the radio frequency apparatus 1002 sends the processed information through the antenna 1001.

The method performed by the network-side device in the foregoing embodiment may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one of the chips is, for example, the baseband processor, and is connected to the memory 1005 by using a bus interface, to invoke a program in the memory 1005 to perform an operation of a network device shown in the foregoing method embodiment.

The network-side device may further include a network interface 1006, and the interface is, for example, a common public radio interface (CPRI).

For example, the network-side device 1000 in this embodiment of this application further includes instructions or a program stored in the memory 1005 and executable on the processor 1004. The processor 1004 invokes the instructions or the program in the memory 1005 to perform the method performed by the modules shown in FIG. 6 or FIG. 7, and same technical effects are achieved. To avoid repetition, details are not described herein again.

An embodiment of this application further provides a non-transitory readable storage medium. The non-transitory readable storage medium stores a program or instructions. When the program or the instructions are executed by a processor, the processes in the embodiments of the inventory method are implemented, and same technical effects can be achieved. To avoid repetition, details are not described herein again.

The processor is a processor in the terminal described in the foregoing embodiments. The non-transitory readable storage medium includes a non-transitory computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement processes in the embodiments of the inventory method, and same technical effects can be achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a non-transitory storage medium. The computer program/program product is executed by at least one processor to implement processes in the embodiments of the inventory method, and same technical effects can be achieved. To avoid repetition, details are not described herein again.

An embodiment of this application further provides an inventory system. The inventory system includes a first communication device and a second communication device. The first communication device may be configured to perform processes in the embodiment 200-300 of the inventory method, and the second communication device may be configured to perform and implement processes in the embodiment 500 of the inventory method, and same technical effects can be achieved. To avoid repetition, details are not described herein again.

It should be noted that in this specification, the term “include”, “comprise”, or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for enabling a terminal or a network-side device to perform the methods described in the embodiments of this application.

The foregoing describes the embodiments of this application with reference to the accompanying drawings. However, this application is not limited to the foregoing implementations. The foregoing implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. An inventory method, comprising:
taking, by a first communication device, inventory of at least two second communication devices based on a multi-thread inventory process.

2. The method according to claim 1, wherein the multi-thread inventory process comprises at least one of the following:
synchronously performing, by the at least two second communication devices, an inventory process, and performing communication data transmission in the inventory process based on an orthogonal transmission resource;
synchronously performing, by the at least two second communication devices, the inventory process, and performing communication data transmission in the inventory process based on a non-orthogonal transmission resource;
asynchronously performing, by the at least two second communication devices, the inventory process, and performing communication data transmission in the inventory process based on the orthogonal transmission resource; or
asynchronously performing, by the at least two second communication devices, the inventory process, and performing communication data transmission in the inventory process based on the non-orthogonal transmission resource, wherein
the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and
the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

3. The method according to claim 1, wherein in a process in which the first communication device takes inventory of the at least two second communication devices based on the multi-thread inventory process, a first command that is sent by the first communication device and that is used to indicate or trigger each of the second communication devices to contend for a channel comprises or indicates at least one of the following:
first synchronization information, used to align a time of each of the second communication devices;
a first rate or a first rate offset, used to indicate a rate or a rate offset with which the second communication device sends first communication data;
a first start time or a first start time offset, used to indicate a start time or a start time offset with which the second communication device sends communication data;
configuration information of a first reference bit, wherein the configuration information comprises a position or a length of a reference bit;
modulation-related information of a first signal, wherein the modulation-related information of the first signal comprises a modulation scheme or a modulation order; or
a length of a first identifier, wherein the first identifier comprises a device identifier or a temporary identifier of the second communication device.

4. The method according to claim 3, wherein in the process in which the first communication device takes inventory of the at least two second communication devices based on the multi-thread inventory process, a first response that is received by the first communication device and that is used to respond to the first command comprises or indicates at least one of the following:
the first identifier, wherein the first identifier comprises the device identifier or the temporary identifier of the second communication device;
a length of to-be-transmitted data;
a supported communication mode;
supported communication resources or resource granularity;
priority-related information; or
quality of service (QoS)-related information.

5. The method according to claim 3, wherein in the process in which the first communication device takes inventory of the at least two second communication devices based on the multi-thread inventory process, a second command that is sent by the first communication device and that is used to reply to a first response sent by the second communication device comprises or indicates at least one of the following:
an identifier list of first devices, wherein a device corresponding to each identifier in the identifier list of the first devices is successfully decoded and allowed for data transmission;
an orthogonal transmission resource position list, wherein the orthogonal transmission resource position list corresponds to the identifier list of the first devices;
a quantity of orthogonal transmission resources;
an amount of transmissible data on an orthogonal transmission resource;
an identifier list of second devices, wherein a device corresponding to each identifier in the identifier list of the second devices is successfully decoded but needs to wait for transmission;
a target timer, wherein the target timer is related to a second communication device that needs to enter a pending state;
a second identifier, used to notify a second communication device that completes the inventory process to enter a silent state, and wake up a second communication device in the pending state to start transmission;
second synchronization information, used to align the time of each of the second communication devices;
a resource granularity of a transmission resource used for communication data transmission;
modulation-related information of a second signal, wherein the modulation-related information of the second signal comprises the modulation scheme or the modulation order;
a length of to-be-transmitted data;
a data padding type in the to-be-transmitted data;
a second rate or a second rate offset, used to indicate the rate or the rate offset with which the second communication device sends the first communication data;
a second start time or a second start time offset, used to indicate the start time or the start time offset with which the second communication device sends the communication data; or
configuration information of a second reference bit, wherein the configuration information comprises the position or the length of the reference bit.

6. The method according to claim 1, wherein in a process in which the first communication device takes inventory of the at least two second communication devices based on the multi-thread inventory process, a second response that is received by the first communication device and that is used to respond to a second command comprises or indicates at least one of the following:
first to-be-transmitted data;
padded first to-be-transmitted data; or
truncated first to-be-transmitted data.

7. The method according to claim 1, wherein in a process in which the first communication device takes inventory of the at least two second communication devices based on the multi-thread inventory process, at least one third command sent by the first communication device to the second communication device comprises or indicates at least one of the following:
a waiting time, wherein the waiting time is used to update timing duration of a target timer;
a length of to-be-transmitted data and a data padding type in the to-be-transmitted data;
a third rate or a third rate offset;
third synchronization information, used to align a time of each of the second communication devices;
a third start time or a third start time offset; or
configuration information of a third reference bit, wherein
a third command is a command other than a first command and a second command in the multi-thread inventory process; or
at least one third response that is sent by the second communication device and that is received by the first communication device comprises or indicates at least one of the following:
a length of to-be-transmitted data;
second to-be-transmitted data;
truncated second to-be-transmitted data; or
padded second to-be-transmitted data, wherein
a third response is a response other than a first response and a second response in a process in which the first communication device takes inventory of the at least two second communication devices based on the multi-thread inventory process.

8. The method according to claim 1, wherein the method further comprises:
in a process in which the first communication device takes inventory of the at least two second communication devices based on the multi-thread inventory process, if a plurality of pieces of received communication data conflict, performing conflict recovery processing on the plurality of pieces of received communication data based on a predetermined conflict signal recovery technology.

9. The method according to claim 1, wherein a first command or a second command is scrambled by using a part or all of a first identifier, and the first identifier comprises a device identifier or a temporary identifier of the second communication device; or
wherein a first command is any one of the following:
a broadcast command; and
a unicast command, wherein the unicast command carries a first identifier of the second communication device;
or
a second command is any one of the following:
a broadcast command; and
a unicast command, wherein the unicast command carries the first identifier of the second communication device.

10. The method according to claim 1, wherein a target command or a target response is transmitted by using at least one of the following:
dedicated signaling, a system message, radio resource control (RRC) signaling, a medium access control control element (MAC CE), downlink control information (DCI), uplink control information (UCI), sidelink control information (SCI), or a physical frame preamble, wherein
the target command comprises at least one of a first command, a second command, or a third command, and the target response comprises at least one of a first response, a second response, or a third response.

11. An inventory method, comprising:
performing, by a second communication device, an inventory process with a first communication device, wherein
an inventory process corresponding to the second communication device and an inventory process corresponding to at least one third communication device belong to a same multi-thread inventory process performed by the first communication device.

12. The method according to claim 11, wherein the multi-thread inventory process comprises at least one of the following:
synchronously performing, by the second communication device, the inventory process with the at least one third communication device, and performing communication data transmission in the inventory process based on an orthogonal transmission resource;
synchronously performing, by the second communication device, the inventory process with the at least one third communication device, and performing communication data transmission in the inventory process based on a non-orthogonal transmission resource;
asynchronously performing, by the second communication device, the inventory process with the at least one third communication device, and performing communication data transmission in the inventory process based on the orthogonal transmission resource; or
asynchronously performing, by the second communication device, the inventory process with the at least one third communication device, and performing communication data transmission in the inventory process based on the non-orthogonal transmission resource, wherein
the synchronously performing the inventory process means that different second communication devices process or wait to process same communication data from the first communication device at any moment in the inventory process, and the asynchronously performing the inventory process means that different second communication devices are allowed to process or wait to process different communication data from the first communication device at a same moment; and
the orthogonal transmission resource is a transmission resource that is used by different second communication devices in a non-overlapping or non-sharing manner, and the non-orthogonal transmission resource is a transmission resource that is used by different second communication devices in an overlapping or sharing manner.

13. The method according to claim 11, wherein in the inventory process corresponding to the second communication device, a first command that is received by the second communication device and that is used to indicate or trigger the second communication device to contend for a channel comprises or indicates at least one of the following:
first synchronization information, used to align a time of each of second communication devices and a time of a third communication device;
a first rate or a first rate offset, used to indicate a rate or a rate offset with which the second communication device sends first communication data;
a first start time or a first start time offset, used to indicate a start time or a start time offset with which the second communication device sends communication data;
configuration information of a first reference bit, wherein the configuration information comprises a position or a length of a reference bit;
modulation-related information of a first signal, wherein the modulation-related information of the first signal comprises a modulation scheme or a modulation order; or
a length of a first identifier, wherein the first identifier comprises a device identifier or a temporary identifier of the second communication device.

14. The method according to claim 11, wherein in the inventory process corresponding to the second communication device, a first response that is sent by the second communication device and that is used to respond to a first command comprises or indicates at least one of the following:
a first identifier, wherein the first identifier comprises a device identifier or a temporary identifier of the second communication device;
a length of to-be-transmitted data;
a supported communication mode;
supported communication resources or resource granularity;
priority-related information; or
quality of service (QoS)-related information.

15. The method according to claim 11, wherein in the inventory process corresponding to the second communication device, a second command that is received by the second communication device and that is used to reply to a first response comprises or indicates at least one of the following:
an identifier list of first devices, wherein a device corresponding to each identifier in the identifier list of the first devices is successfully decoded and allowed for data transmission;
an orthogonal transmission resource position list, wherein the orthogonal transmission resource position list corresponds to the identifier list of the first devices;
a quantity of orthogonal transmission resources;
an amount of transmissible data on an orthogonal transmission resource;
an identifier list of second devices, wherein a device corresponding to each identifier in the identifier list of the second devices is successfully decoded but needs to wait for transmission;
a target timer, wherein the target timer is related to a second communication device that needs to enter a pending state;
a second identifier, used to notify a second communication device that completes the inventory process to enter a silent state, and wake up a second communication device in the pending state to start transmission;
second synchronization information, used to align a time of each of second communication devices and a time of a third communication device;
a resource granularity of a transmission resource used for communication data transmission;
modulation-related information of a second signal, wherein the modulation-related information of the second signal comprises a modulation scheme or a modulation order;
a length of to-be-transmitted data;
a data padding type in the to-be-transmitted data;
a second rate or a second rate offset, used to indicate a rate or a rate offset with which the second communication device sends first communication data;
a second start time or a second start time offset, used to indicate a start time or a start time offset with which the second communication device sends communication data; or
configuration information of a second reference bit, wherein the configuration information comprises a position or a length of a reference bit.

16. The method according to claim 11, wherein in the inventory process corresponding to the second communication device, a second response that is sent by the second communication device and that is used to respond to a second command comprises or indicates at least one of the following:
first to-be-transmitted data;
padded first to-be-transmitted data; or
truncated first to-be-transmitted data;
wherein the method further comprises:
in a case that a length of to-be-transmitted data does not reach or exceeds a predetermined value, performing truncation processing or padding processing on the to-be-transmitted data until the length of the to-be-transmitted data reaches the predetermined value; and
determining the second response based on the truncated or padded to-be-transmitted data.

17. The method according to claim 11, wherein at least one third command that is sent by the first communication device and that is received by the second communication device carries at least one of the following:
a waiting time, wherein the waiting time is used to update timing duration of a target timer;
a length of to-be-transmitted data and a data padding type in the to-be-transmitted data;
a third rate or a third rate offset;
third synchronization information, used to align a time of each of second communication devices and a time of a third communication device;
a third start time or a third start time offset; or
configuration information of a third reference bit, wherein
a third command is a command other than a first command and a second command in the inventory process corresponding to the second communication device; or
at least one third response sent by the second communication device to the first communication device comprises or indicates at least one of the following:
a length of to-be-transmitted data;
second to-be-transmitted data;
truncated second to-be-transmitted data; or
padded second to-be-transmitted data, wherein
a third response is a response other than a first response and a second response in the inventory process corresponding to the second communication device.

18. The method according to claim 11, wherein a first command or a second command is scrambled by using a part or all of a device identifier;
wherein a first command is any one of the following:
a broadcast command; and
a unicast command, wherein the unicast command carries a first identifier of the second communication device;
or
a second command is any one of the following:
a broadcast command; and
a unicast command, wherein the unicast command carries the first identifier of the second communication device.

19. A communication device, comprising a processor and a memory, wherein the memory stores a program or instructions executable on the processor, and the program or the instructions, when executed by the processor, cause the communication device to perform:
taking inventory of at least two second communication devices based on a multi-thread inventory process.

20. A communication device, comprising a processor and a memory, wherein the memory stores a program or instructions executable on the processor, and when the program or the instructions are executed by the processor, the steps of the inventory method according to claim 11 are implemented.
